(19) United States
(12) Patent Application Publication
(10) Pub. No.: US 2026/0335879 A1
(43) Pub. Date: Oct. 29, 2026

(54) DISPOSABLE SYSTEM FOR ANALYSIS OF HEMOSTATIC FUNCTION

(71) Applicant: HemoSonics LLC, Durham, NC (US)

(72) Inventors: Sydney Schiff, Raleigh, NC (US); Kevin Gibson, Durham, NC (US); Francesco Viola, Chapel Hill, NC (US); Amanda Lugo, Durham, NC (US); Meredith Eagar, Durham, NC (US)

(21) Appl. No.: 19/656,588

(22) Filed: Apr. 23, 2026

Related U.S. Application Data
(60) Provisional application No. 63/793,253, filed on Apr. 23, 2025.

(51) Int. Cl. B01L 3/00

(52) U.S. Cl. CPC B01L 3/502; B01L 2200/025; B01L 2200/026; B01L 2200/0605; B01L 2200/0684; B01L 2200/146; B01L 2200/16; B01L 2300/0672; B01L 2300/0681; B01L 2300/0883

(57) ABSTRACT

A disposable system, in some embodiments, includes a test cartridge device configured to operate with a testing system for evaluation of hemostasis in a subject by in vitro evaluation of a test sample from the subject. The disposable system, in some embodiments, is configured to interrogate the test sample to evaluate clot stiffness, strength, or other mechanical properties of the test sample to assess the function of various physiological processes occur during coagulation and/or dissolution of the resulting clot.

### CROSS-REFERENCE TO RELATED APPLICATION

This application claims priority to and benefit of U.S. Provisional Patent Application Ser. No. 63/793,253, entitled “DISPOSABLE SYSTEM FOR ANAYLYSIS OF HEMOSTATIC FUNCTION,” filed Apr. 23, 2025, which is hereby incorporated by reference herein in its entirety.

### TECHNICAL FIELD

The present application relates to devices, systems and methods for evaluating hemostasis in a subject by preparation and analysis of a test sample from the subject.

### BACKGROUND

Hemostasis, the physiological control of bleeding, is a complex process incorporating the vasculature, platelets, coagulation factors, fibrinolytic proteins, and a variety of other activators and inhibitors. Disruption of hemostasis plays a central role in the onset of myocardial infarction, stroke, pulmonary embolism, deep vein thrombosis and excessive bleeding. Consequently, in vitro diagnostics (IVD) are critically needed to quantify hemostatic function/dysfunction and direct appropriate treatment.

Existing global hemostasis testing systems often require collection of a large sample volume, which can present significant challenges in various clinical and point-of-care settings, especially when testing pediatric patients or when repeated sampling and testing is necessary. Thus, there is a need for hemostasis testing systems that can effectively and accurately measure physiological properties of blood using smaller sample volumes.

### SUMMARY

Provided are cartridge devices, instrument systems, and automated sample-processing methods for clinical point-of-care evaluation of hemostasis. The disposable cartridge device, in some embodiments, evaluates the key indexes of hemostasis in a subject by in vitro evaluation of a test sample from the subject. The exemplary cartridge device is configured to operatively couple to a standard holding/collecting device (e.g., syringe, pipette, transfer pipette, or vacutainer) employed in clinical laboratories and operate with reduced sample volume, thus facilitating the use of the small holding/collecting tube (e.g., 1.8-2 mL). The cartridge device employs (i) a manifold that directly feeds the output from the holding/collecting tube to each of the processing channels in combination with (ii) a gas trap that removes gases from the manifold structure prior to the channel sample processing. The manifold structures for each of the channels each have an effective volume of the same degrees as one another to facilitate sample flow from the cartridge input to each processing step without the need for metering or metering-associated structure.

The testing system, in some embodiments, is configured to interrogate the test sample in the disposable cartridge to evaluate clot stiffness, clot strength, shear modulus, or other mechanical or viscoelastic properties of the test sample to assess the function of various physiological processes that occur during coagulation and/or dissolution of the resulting clot, for example, for the evaluation key indexes of hemostasis. The sample can include in whole, or in part, whole blood, plasma, platelet rich plasma, or platelet poor plasma. Furthermore, the sample can include one or more reagent (such as anticoagulants or anti-platelet drugs to nullify or counter reagents that might be present in the blood as collected), or one or more pharmacological treatment (such as in the case of heparin or low molecular weight heparin) or other inert components (such as polystyrene beads, buffers and stabilizers, etc.) that are added to the test sample before the cartridge device being used.

The disposable system facilitates the point of care evaluation of hemostasis of a test sample that is robust (e.g., can be performed in non-laboratory environment), rapid (e.g., only to take a few minutes to perform), easy-to-use and provides clear results (e.g., that are direct to the functional components of hemostasis), and facilitates identification of potential hemostasis defects. The exemplified device automates one or more pre-measurement steps that minimizes sample manipulation steps required for the user, thereby improving test reproducibility and/or test quality. The disposable system, in some embodiments, includes a plurality of testing circuits each having a fluid pathway configured to prepare a test sample of blood for evaluation by a measurement device. In each testing circuit, a portion of the test sample is introduced to a reagent or combination of reagents specific to that testing circuit.

The disposable system, in some embodiments, is configured to condition the respective test samples prior to, during, and/or after the mixing with the reagent(s), to optimize the proper actions of applicable blood component and chemistry (e.g., vasculature components, platelets or other cellular components, coagulation factors, fibrinolytic components, and any other inhibitor or activator of hemostatic function, etc.) being evaluated.

In various aspects, disclosed herein is an apparatus. The apparatus includes: a housing; an input port integrally formed with the housing that is structurally configured to receive contents of a sample holding tube; a gas trap in fluidic communication with the input port, wherein the gas trap is structurally configured to receive a liquid sample from the input port and to facilitate separation of gases from the liquid sample; and a fluidic manifold in fluidic communication with the gas trap. The fluidic manifold is configured to receive the sample from the gas trap and to direct the degassed sample into two or more fluidic circuits downstream to the fluidic manifold. Each of the two or more fluidic circuits includes i) a reagent channel in fluidic communication with the fluidic manifold. The degassed sample is introduced to one or more reagents located in a corresponding fluidic circuit to form a mixed sample. Each fluidic circuit also includes ii) a testing chamber in fluidic communication with the reagent channel, the testing chamber being structurally configured for interrogation by a measurement system configured to determine at least one viscoelastic property of the mixed sample.

In some aspects, each respective reagent channel comprises one or more pockets configured to house at least one lyophilized bead comprising one or more reagents. In some aspects, at least one of the two or more fluidic circuits includes one or more lyophilized reagents that are located on one or more surfaces thereof (e.g., lyophilized on each of the surfaces; lyophilized as films placed on, or adhered to, one or more of the surfaces). In some aspects, at least one of the two or more fluidic circuits includes one or more reagents that are processed onto surfaces thereof (e.g., dried on the surfaces; spray coated on the surfaces; baked onto the surfaces).

In some aspects, each of the two or more fluidic circuits further includes a metering channel positioned between the fluidic manifold and the reagent channel, wherein each metering channel is configured to receive a metered sample from a respective output of the fluidic manifold.

In some aspects, at least one of the two or more fluidic circuits includes two or more reagent pockets.

In some aspects, the input port forms a part of a needle assembly structurally configured to establish fluidic communication and evacuate contents of the sample holding tube.

In some aspects, the needle assembly comprises the input port and a second port, wherein the second port is configured to vent a liquid or gas into the sample holding tube so as to promote evacuation of the contents therein. The input port, in some aspects, is located (e.g., concentrically located) within a second port configured to vent a liquid or gas into the sample holding tube so as to cause evacuation of the contents of the sample holding tube.

In some aspects, the input port is structurally configured to couple to a luer lock configured to connect to a sample holding tube. In some aspects, the input port comprises a luer lock configured to connect to the sample holding tube, wherein the sample holding tube is a syringe. In some aspects, the needle assembly includes the input port and a second port, wherein the second port is configured to vent a liquid or gas into the sample holding tube so as to promote evacuation of the contents therein. In some aspects, the input port is structurally configured to couple to a luer lock configured to connect to the sample holding tube.

In some aspects, the needle assembly includes an aspiration needle and a venting needle, wherein the venting needle is concentrically arranged within the aspiration needle. In some aspects, the aspiration needle comprises a slot that at least partially exposes the venting needle therewithin. In some aspects, a tip of the venting needle is axially positioned between the slot and a tip of the aspiration needle. In some aspects, a tip of the aspiration needle is beveled. In some aspects, a tip of the aspiration needle is blunt. In some aspects, the aspiration needle and/or the venting needle are fixedly secured to the housing using one or more adhesive pockets. In some aspects, the one or more adhesive pockets comprises a first adhesive pocket securing the aspiration needle and second adhesive pocket securing the venting needle.

In some aspects, the apparatus further includes a sample container guide shaped to receive the sample holding tube and to align the sample holding tube to the input port. In some aspects, the sample container guide is integrally formed with the input port. In some aspects, the sample container guide is configured to be separately attached to the input port. In some aspects, an inner surface of the sample container guide comprises one or more protrusions to align the sample holding tube to the input port. In some aspects, the one or more protrusions are configured to urge the sample holding tube towards a radial center of the sample container guide.

In some aspects, at least a portion of the metering channels comprise a shape and/or material optimized to facilitate heating and/or cooling of the sample to, or near, a desired temperature.

In some aspects, the metering channel includes a serpentine-shaped conduit.

In some aspects, at least a portion of the metering channels are configured to mate with a corresponding thermal regulating system of the measurement system to condition the received sample to a desired temperature.

In some aspects, at least a portion of the metering channels are in physical proximity with a sensor (e.g., of the measurement system) configured to determine a temperature (e.g., of the sample received in each of the two or more fluidic circuits). In some aspects, the sensor is selected from group consisting of a thermistor, a thermocouple, and an optical sensor (e.g., an IR sensor). In some aspects, the temperature is determined by measuring a temperature of the thermal regulating system.

In some aspects, each of the two or more fluidic circuits comprises a third set of fluid pathways in fluidic communication between a respective reagent channel and testing chamber, wherein at least a portion of third set of fluid pathways are arranged as a serpentine-shaped conduit.

In some aspects, each of the metering channels is connected to a respective first pressure port, wherein pressure when applied to the first pressure port causes the filling of the metering channel through the fluidic manifold.

In some aspects, the apparatus further includes a filter positioned within the first pressure port, wherein the filter is configured to allow air to move through the first pressure port but prevent fluid from moving there through.

In some aspects, the fluidic manifold is further connected to a vent port, wherein the vent port is configured to be closed while the sample is metered into an aliquot in the metering channel and further configured to be open to atmospheric pressure after the sample is metered into the aliquot in the metering channel.

In some aspects, the serpentine-shaped conduit forms a serpentine reservoir between the testing chamber and the reagent channel, and wherein a substantial portion of the contents of a sample holding tube (e.g., 60% or more, 65% or more, 70% or more, 75% or more, 80% or more, 85% or more, 90% or more, 91% or more, 92% or more, 93% or more, 94% or more, 95% or more, 96% or more, 97% or more, 98% or more, or 99% or more) is directed through portions of the serpentine-shaped conduits.

In some aspects, the metered sample is alternately directed through portions of the two or more fluidic circuits to facilitate mixing of the metered sample and the reagent, or a combination of reagents. In some aspects, the metered sample is alternately directed, for each of the two or more fluidic circuits, between a first position in a fluidic circuit and a second position in the fluidic circuit, wherein a path between the first position and second portion includes at least a portion of the serpentine-shaped conduit.

In some aspects, each of the testing chambers is connected to a second pressure port, wherein when pressure is applied to the second pressure port the test sample flows toward the testing chamber through a respective serpentine-shaped conduit.

In some aspects, when pressure is applied to the second pressure port in a reversed direction causes the test sample to flow away from the testing chamber through the respective serpentine-shaped conduit. In some embodiments, the apparatus includes two or more fluidic pathways in fluidic communication with the second pressure port for all of the two or more fluidic circuits, wherein the two or more fluidic pathways are configured to provide the negative pressure to the second pressure port for all of the two or more fluidic circuits.

In some aspects, the serpentine conduit includes an optical detection zone. The optical detection zone can be used to facilitate optical detection of the metered sample in the serpentine conduit or a location of the sample in the serpentine conduit.

In some aspects, each of the two or more fluidic circuits further comprises a mixing zone between the testing chamber and the metering channel, the mixing zone comprising one or more ferromagnetic elements (e.g., beads or bars) therein.

In some aspects, at least one of the two or more fluidic circuits comprises one or more quality testing ports, wherein the one or more quality testing ports is configured to be sensed optically or electrically. In some aspects, the one or more quality testing ports is configured to be sensed optically, wherein the quality testing port is transparent.

In some aspects, the one or more quality testing ports is configured to be sensed electrically, wherein quality testing port comprises one or more sensing electrodes.

In some aspects, the one or more quality testing ports is configured to be sampled for characteristics for the metered sample (e.g., for pressure, presence of flow, flow rate, temperature). In some aspects, at least one of the one or more quality testing ports is configured to be sampled for characteristics of the metered sample.

In some embodiments, for each of the two or more fluidic circuits, the testing chamber comprises a mechanism to couple energy into the testing chamber to perform the measurements such as in the case of a lens configured to direct ultrasonic pulses into to the testing chamber. In some aspects, the testing chamber comprises a lens configured to direct ultrasonic pulses generated by the measurement system into the testing chamber.

In some aspects, for each of the two or more fluidic circuits, a metering channel is in fluidic communication with the fluidic manifold, the one or more reagent pockets, and the testing chamber.

In some aspects, a volume of the sample in the sample holding tube is less than 3 mL.

In some aspects, the sample holding tube comprises a 2 mL tube.

In some aspects, the gas trap comprises one or more capture pockets positioned above a fluid path of the sample through the gas trap, wherein the capture pockets are configured to collect and retain gases from the sample.

In some aspects, the gas trap comprises one or more impedance baffles positioned in-line of the one or more capture pockets, the impedance baffles configured such that when a fluid contacts the impedance baffles, gases in the fluid are redirected towards the capture pockets.

In some aspects, an inlet of the gas trap is disposed above an outlet of the gas trap.

In some aspects, at least one of the reagents located in the two or more fluidic circuits is selected from the group consisting of an intrinsic pathway activator, an extrinsic pathway activator, and a coagulation activator.

In some aspects, at least one of the reagents located in the two or more fluidic circuits includes an intrinsic pathway activator (e.g., kaolin, celite, glass, ellagic acid, micronized silica, Hageman factor, etc.) or a combination therewith.

In some aspects, at least one of the reagents located in the two or more fluidic circuits includes an extrinsic pathway activator (e.g., tissue factor, recombinant tissue factor, thromboplastin, etc.) or a combination therewith.

In some aspects, at least one of the reagents located in the two or more fluidic circuits includes a coagulation activator (e.g., thrombin, factor Xa, factor XIa, factor XIIa, reptilase, ecarin, Russell's viper venom or other snake venoms, etc.) or a combination therewith.

In some aspects, at least one of the reagents located in the two or more fluidic circuits includes a platelet activator or platelet inhibitor (e.g., GPIIb/IIIa inhibitors (e.g., abciximab, eptifibatide, tirofiban, roxifiban, orbofiban), cytochalasin D, blebbistatin, PAR1 inhibitors, PAR4 inhibitors, glycoprotein IB inhibitors, TRAP, ADP, arachidonic acid, ADP or P2Y12 inhibitors (e.g., cangrelor, ticagrelor, etc), non-steroidal anti-inflammatory drugs, platelet activating factor, ristocetin, epinephrine, etc.) or a combination therewith.

In some aspects, at least one of the reagents located in the two or more fluidic circuits includes a fibrinolytic functions activator or inhibitor (e.g., tPA, uKA, streptokinase, TAFIa, plasmin/plasminogen, aprotinin, epsilon-aminocaproic acid, tranexamic acid, plasminogen activator inhibitor 1 (PAI1), α2-antiplasmin (α2-AP), or plasmin-antiplasmin complexes, carboxypeptidase inhibitor) or a combination therewith.

In some aspects, at least one of the reagents located in the two or more fluidic circuits includes FXIIIa, FXIIIa inhibitors or a combination therewith.

In some aspects, at least one of the reagents located in the two or more fluidic circuits includes thrombomodulin or a combination therewith.

In some aspects, at least one of the reagents located in the two or more fluidic circuits includes low molecular weight heparin or a combination therewith.

In some aspects, at least one of the reagents located in the two or more fluidic circuits includes Hexadimethrine bromide (polybrene) or a combination therewith.

In some aspects, at least one of the reagents located in the two or more fluidic circuits includes heparin or a combination therewith.

In some aspects, at least one of the reagents located in the two or more fluidic circuits includes corn trypsin inhibitor or a combination therewith.

In some aspects, at least one of the reagents located in the two or more fluidic circuits includes adenosine or a combination therewith.

In some aspects, at least one of the reagents located in the two or more fluidic circuits includes GPRP (Gly-Pro-Arg-Pro) or a combination therewith.

In some aspects, at least one of the reagents located in the two or more fluidic circuits includes calcium or a combination therewith.

In some aspects, at least one of the reagents located in the two or more fluidic circuits includes fibronectin or a combination therewith.

In some aspects, at least one of the reagents located in the two or more fluidic circuits includes collagen or a combination therewith.

In some aspects, at least one of the reagents located in the two or more fluidic circuits includes an immuno-detection reagent or a combination therewith.

In some aspects, at least one of the reagents located in the two or more fluidic circuits includes heparinase I or a combination therewith.

In some aspects, at least one of the reagents located in the two or more fluidic circuits includes endothelial cells or activated endothelial cells.

In some aspects, the one or more reagents includes one or more reagents selected from the group consisting of a platelet activator, a platelet inhibitor, and an agonist.

In some aspects, a first set of one or more reagents includes an intrinsic pathway activator, a second set of one or more reagents includes an extrinsic pathway activator and a fibrinolysis inhibitor, a third set of one or more reagents includes an extrinsic pathway activator, and a fourth set of one or more reagents includes an extrinsic pathway activator and a platelet inhibitor.

In some aspects, the measurement system is selected from the group consisting of a sonorheometry-based system, thromboelastography-based system, a thromboelastometry-based system, an optical-based system, a fluorescence-based system, a colorimetric-based system, an aggregometry-based system, a resonance-based system, and an electrical impedance-based system.

In another aspect, disclosed herein is an apparatus. The apparatus includes a housing; an input port integrally formed with the housing that is structurally configured to receive contents of a sample holding tube; a fluidic manifold in fluidic communication with the input port. The fluidic manifold is configured to receive the sample from the input port and to direct a metered sample into each of two or more fluidic circuits downstream to the fluidic manifold. Each of the two or more fluidic circuits includes i) a metering channel including a serpentine-shaped conduit in fluid communication with the fluidic manifold. The metering channel is configured to receive the metered sample from a respective output of the fluidic manifold. Each of the two or more fluidic circuits also includes ii) a reagent channel in fluidic communication with the fluidic manifold. The metered sample can be introduced to one or more reagents located in a corresponding fluidic circuit to form a mixed sample. Each of the two or more fluidic circuits further includes iii) a testing chamber in fluidic communication with the reagent channel, the testing chamber being structurally configured for interrogation by a measurement system configured to determine at least one viscoelastic property of the mixed sample.

In another aspect, disclosed is an apparatus. The apparatus includes: a housing; an input port integrally formed with the housing that is structurally configured to receive contents of a sample holding tube; and a fluidic manifold in fluidic communication with the input port. The fluidic manifold is configured to receive the sample from the input port and to direct a metered sample into each of two or more fluidic circuits downstream to the fluidic manifold. Each of the two or more fluidic circuits includes i) a metering channel in fluid communication with the fluidic manifold. The metering channel is configured to receive the metered sample from a respective output of the fluidic manifold. Each fluidic circuit also includes ii) a reagent channel in fluidic communication with the fluidic manifold. The metered sample is introduced to one or more reagents located in a corresponding fluidic circuit to form a mixed sample. Each of the two or more fluidic circuit further includes iii) a testing chamber in fluidic communication with the reagent channel, the testing chamber being structurally configured for interrogation by a measurement system configured to determine at least one viscoelastic property of the mixed sample. The apparatus is configured to receive a sample of 3 mL or less.

In another aspect, disclosed herein is an apparatus. The apparatus includes: a housing; an input port integrally formed with the housing that is structurally configured to receive contents of a sample holding tube; a fluidic manifold in fluidic communication with the input port. The fluidic manifold is configured to receive the sample from the input port and to direct a metered sample into each of two or more fluidic circuits downstream via the metering channels. Each of the two or more fluidic circuits includes i) a metering channel in fluid communication with the fluidic manifold. The metering channel is configured to receive the metered sample from a respective output of the fluidic manifold. Each fluidic circuit also includes ii) a reagent channel in fluidic communication with the fluidic manifold. The metered sample is introduced to one or more reagents located in a corresponding fluidic circuit to form a mixed sample. Each of the two or more fluidic circuits further includes iii) a testing chamber in fluidic communication with the reagent channel, the testing chamber being structurally configured for interrogation by a measurement system configured to determine at least one viscoelastic property of the mixed sample.

Also described herein are methods, for example, methods of mixing a sample with one or more reagents in an apparatus and testing the mixed sample to assess hemostasis. In some aspects, the method includes receiving a sample from a sample holding tube; flowing the sample through a gas trap to facilitate separation of gases from the sample; separating the degassed sample into two or more test samples and flowing the two or more test samples into a two or more corresponding test circuits that include one or more reagents and a testing chamber; mixing the two or more test samples in the two or more test circuits with the one or more reagents to form two or more corresponding mixed aliquots; and flowing the two or more mixed aliquots to two or more corresponding testing chambers in the test circuits; and measuring one or more viscoelastic properties from the two or more mixed aliquots in the corresponding testing chambers.

In some aspects, the method further includes: adjusting the temperature of the metered sample in the metering channel to approximate body temperature prior to mixing the two or more test samples with the one or more reagents in the test circuits.

In some aspects, the test fluid is moved into the metering channels through the fluidic manifold in response to a first applied positive or negative pressure that is applied by, or generated from, the measurement system.

In some aspects, the method further includes: conditioning the metering samples in the metering channels to, or substantially near, a desired temperature, wherein the test fluid is mixed with the one or more reagents in a respective fluidic pathway following exit from the metering channels.

In some aspects, the method further includes: isolating the test fluid in the metering channel to prevent the test fluid from contacting the one or more reagents during the filling of the metering channel.

In some aspects, a second applied positive or negative pressure is applied by, or generated from, the measurement system at a first port in communication with the serpentine pathway so as to move a respective metered sample in the second direction.

In some aspects, the first applied positive or negative pressure is applied by, or generated from, the measurement system in reversed so as to move a respective metered sample in the second direction.

In some aspects, the receiving the mixed aliquot in the testing chamber further includes: receiving a negative or differential pressure via the second pressure port, wherein the second pressure port is further in fluid communication with the testing chamber.

In some aspects, the testing chamber is downstream of the serpentine pathway and the second pressure port is downstream of the testing chamber.

In some aspects, the one or more reagents is in the form of one or more lyophilized beads.

In some aspects, the one or more reagents is selected from the group consisting of an intrinsic pathway activator, an extrinsic pathway activator, and a coagulation activator.

In some aspects, the one or more reagents comprises an intrinsic pathway activator.

In some aspects, the one or more reagents comprises an extrinsic pathway activator.

In some aspects, the one or more reagents is selected from the group consisting of a platelet activator, a platelet inhibitor, and an agonist.

In some aspects, the one or more reagents comprises a coagulation activator selected from the group consisting of kaolin, Hageman factor, celite, glass, ellagic acid, micronized silica, tissue factor, recombinant tissue factor, thromboplastin, thrombin, factor Xa, factor XIa, factor XIIa, reptilase, ecarin, and Russell's viper venom.

In some aspects, the one or more reagents comprises a platelet activator or inhibitor selected from the group consisting of abciximab, eptifibatide, tirofiban, roxifiban, orbofiban, cytochalasin D, blebbistatin, PAR1 inhibitors, PAR4 inhibitors, glycoprotein I.B. inhibitors, thrombin receptor activating peptide (TRAP), adenosine diphosphate (A.D.P.), arachidonic acid, and P2Y12 inhibitors (cangrelor, ticagrelor, etc).

In some aspects, the one or more reagents comprises an agonist or antagonist of fibrinolysis selected from the group consisting of tPA, uKA, streptokinase, TAFIa, plasmin/plasminogen, aprotinin, epsilon-aminocaproic acid, tranexamic acid, plasminogen activator inhibitor 1 (PAI1), α2-antiplasmin (α2-AP), plasmin-antiplasmin complexes, and carboxypeptidase inhibitor.

In some aspects, the one or more reagents comprises a reagent selected from the group consisting of FXIIIa, FXIIIa inhibitor, Hexadimethrine bromide (polybrene), heparinase, ristocetin, heparin, bivalirudin, hirudin, low molecular weight heparin, corn trypsin inhibitor, adenosine, GPRP, calcium, fibronectin, collagen, epinephrine, immuno-detection reagent, direct thrombin inhibitor, factor Xa inhibitor, direct thrombin inhibitor, and thrombomodulin.

In some aspects, a first set of one or more reagents comprise an intrinsic pathway activator, wherein a second set of one or more reagents comprises an extrinsic pathway activator and a fibrinolysis inhibitor, wherein a third set of one or more reagents comprises an extrinsic pathway activator, and wherein a fourth set of one or more reagents comprises an extrinsic pathway activator and a platelet inhibitor.

In some aspects, a set of one or more reagent pockets associated with a testing chamber comprises kaolin, calcium, buffers, and stabilizers.

In some aspects, a set of one or more reagent pockets associated with a testing chamber comprises: a combination of kaolin, heparinase I, calcium, buffers and stabilizers; or a combination of thromboplastin, polybrene, tranexamic acid, calcium, buffers, and stabilizers.

In some aspects, a set of one or more reagent pockets associated with a testing chamber comprises thromboplastin, polybrene, calcium, buffers, and stabilizers.

In some aspects, a set of one or more reagent pockets associated with a testing chamber comprises thromboplastin, polybrene, at least one of abciximab and cytochalasin D, calcium, buffers, and stabilizers.

In some aspects, a set of one or more reagent pockets associated with a testing chamber comprises thromboplastin, polybrene, abciximab, calcium, buffers, and stabilizers.

In some aspects, a first set of one or more reagents comprise comprises kaolin, calcium, buffers, and stabilizers, wherein a second set of one or more reagents comprises a combination of kaolin, heparinase I, calcium, buffers and stabilizers, wherein a third set of one or more reagents comprises thromboplastin, polybrene, calcium, buffers, and stabilizers, and wherein a fourth set of one or more reagents comprises thromboplastin, polybrene, abciximab, buffers and stabilizers.

In some aspects, a first set of one or more reagents includes kaolin, calcium, buffers, and stabilizers, a second set of one or more reagents includes a combination of thromboplastin, polybrene, calcium, buffers, and stabilizers, a third set of one or more reagents includes thromboplastin, polybrene, calcium, buffers, and stabilizers, and a fourth set of one or more reagents includes thromboplastin, polybrene, abciximab, calcium, buffers and stabilizers.

In some aspects, the measurement system is configured to determine at least one of: a clot time of a first mixed sample, and a clot stiffness or a heparinase clot time of a second mixed sample.

In some aspects, the one or more viscoelastic properties measured include a clot stiffness, a clot stiffness change, and a clot reduction differential of a first mixed sample.

In some aspects, the measurement system is configured to determine shear modulus of a first mixed sample.

In some aspects, the measurement system is configured to determine one or more viscoelastic properties of a second mixed sample.

In some aspects, the measurement system is selected from the group consisting of a sonorheometry-based system, thromboelastography-based system, a thromboelastometry-based system, an optical-based system, a fluorescence-based system, a colorimetric-based system, an aggregometry-based system, a resonance-based system, and an electrical impedance-based system.

In some aspects, the method further includes: mixing the at least one metered sample using one or more ferromagnetic elements (e.g., beads or bars).

In some aspects, the two or more mixed aliquots are flowed from a respective inlet of the two or more corresponding testing chambers to an outlet positioned below the inlet.

In some aspects, a sum of volumes of the metered samples in the metering channels corresponds to 60% or more (e.g., 65% or more, 70% or more, 75% or more, 80% or more, 85% or more, 90% or more, 95% or more) of a volume of the sample in the sample holding tube.

In another aspect, disclosed herein is a method of mixing a sample with one or more reagents in an apparatus and testing the mixed sample to assess hemostasis. In some aspects, the method includes: receiving a sample from a sample holding tube; separating the sample into two or more test samples and flowing the two or more test samples into a two or more corresponding test circuits that each include a metering channel, one or more reagent channels, and a testing chamber in fluidic communication; mixing the two or more test samples in the two or more test circuits with the one or more reagents to form two or more corresponding mixed aliquots; and flowing the two or more mixed aliquots to two or more corresponding testing chambers in the test circuits; and measuring one or more viscoelastic properties from the two or more mixed aliquots in the corresponding testing chambers, wherein a sum of volumes of the two or more test samples in the metering channels corresponds to 60% or more, 65% or more, 70% or more, 75% or more, 80% or more, 85% or more, or 90% or more of a volume of the sample in the sample holding tube.

Also described herein is an apparatus configured to perform any of the methods described herein.

These and other features and advantages of the present invention will become more readily apparent to those skilled in the art upon consideration of the following detailed description and accompanying drawings, which describe both the preferred and alternative embodiments of the present invention.

### BRIEF DESCRIPTION OF THE DRAWINGS

The accompanying drawings, which are incorporated in and constitute a part of this specification, illustrate embodiments and together with the description, serve to explain the principles of the methods and systems:

FIG. 1 shows a perspective view of an example biological sample input of a cartridge for use in a disposable system, in accordance with an illustrative embodiment.

FIG. 2 shows a side cross-sectional view of the example biological sample input of FIG. 1 with a casing, in accordance with an illustrative embodiment.

FIG. 3 shows a side cross-sectional view of the example biological sample input of FIG. 2 with a sample holding tube attached thereon, in accordance with an illustrative embodiment.

FIG. 4 shows a detailed view of the example biological sample input of FIG. 3, in accordance with an illustrative embodiment.

FIG. 5 shows a perspective view detailing biological fluid pathways of four testing circuits (e.g., Hemostasis testing circuits) that are located on a sample preparation plane, in accordance with an illustrative embodiment.

FIG. 6 shows a back-side of the cartridge of FIG. 5 and includes an interconnection plane that interfaces to the sample preparation plane, that collectively form the biological fluid pathways for the testing circuits, in accordance with an illustrative embodiment.

FIG. 7 shows a detailed cross-sectional view of the gas trap of FIG. 5, in accordance with an illustrative embodiment.

FIGS. 8A-8B show example display screens of a hemostasis measuring system depicting various hemostatic parameters (CT=clot time; CTH=clot time with heparinase; CTR=clot time ratio; CS=clot stiffness; PCS=platelet contribution to clot stiffness; and FCS=fibrinogen contribution to clot stiffness). FIG. 8A depicts a dial display showing parameters within the normal reference range while FIG. 8B shows a dial display for a test sample having several parameters outside the normal range (shown by the arc overlaying a portion of the dials).

FIG. 9 shows an example testing chamber section for use with the example cartridge, in accordance with an illustrative embodiment.

FIG. 10 shows a cross-sectional view of an example testing chamber in the example testing chamber section, in accordance with an illustrative embodiment.

FIG. 11 shows a detailed cross-sectional view of the example testing chamber of FIG. 10, in accordance with an illustrative embodiment.

FIG. 12 shows a cross-sectional view of the disposable system operatively coupled to a measurement system, in accordance with an illustrative embodiment.

FIG. 13 shows an example shear modulus versus time curve, in accordance with an illustrative embodiment.

FIG. 14 shows an example of shear modulus curves obtained with an activator of coagulation and with and without a fibrinolysis inhibitor. A differential comparison of these curves can provide information about the fibrinolytic activity of the sample.

FIG. 15 shows differential metrics that can be measured from shear modulus curves obtained with an activator of coagulation and with and without a fibrinolysis inhibitor.

FIG. 16 shows a schematic illustration of an input section of an example cartridge according to another illustrative embodiment.

FIG. 17 shows an enlarged view of the needle assembly depicted in FIG. 16.

FIGS. 18A-18B shows an enlarged front (FIG. 18A) and rear (FIG. 18B) views of various pathways and chambers of the input section depicted in FIG. 16.

FIG. 19 shows an example input section with a sample container guide according to one illustrative example.

FIG. 20 shows an example sample container guide having alignment protrusions according to one illustrative example.

FIG. 21 shows a schematic illustration of an input section of an example cartridge having an integrally formed sample container guide according to an illustrative embodiment.

FIG. 22 shows a schematic illustration of an example cartridge having an integrally formed sample container guide according to an illustrative embodiment.

FIG. 23 shows a front view of an example cartridge having an integrally formed sample container guide according to an illustrative embodiment.

FIG. 24 shows a rear view of an example cartridge having an integrally formed sample container guide according to an illustrative embodiment.

FIG. 25 shows a cross-sectional view of an example cartridge having an integrally formed sample container guide according to an illustrative embodiment.

### DETAILED DESCRIPTION

The present invention now will be described more fully hereinafter with reference to specific embodiments of the invention. Indeed, the invention can be embodied in many different forms and should not be construed as limited to the embodiments set forth herein; rather, these embodiments are provided so that this disclosure will satisfy applicable legal requirements.

As used in the specification, and in the appended claims, the singular forms “a,” “an,” “the,” include plural referents unless the context clearly dictates otherwise.

The term “comprising” and variations thereof as used herein are used synonymously with the term “including” and variations thereof and are open, non-limiting terms.

As used throughout, by a “subject” is meant an individual. The subject may be a vertebrate, more specifically a mammal (e.g., a human, horse, pig, rabbit, dog, sheep, goat, non-human primate, cow, cat, guinea pig or rodent), a fish, a bird or a reptile or an amphibian. The term does not denote a particular age or sex.

The apparatus described here includes a single-use cartridge apparatus configured to facilitate in vitro assessment of one or more hemostatic functions. Hemostatic function refers to a functional role of various blood components such coagulation factors, fibrinogen, platelets, fibrinolytic factors, and components of the vasculature. The cartridge apparatus and associated measurement system, in some embodiments, are configured to assess hemostatic function by measuring changes in at least one mechanical property of the tested sample when such sample is exposed to one or more reagents. In some embodiments, the cartridge apparatus and its testing chambers are configured to facilitate measurements of viscoelastic properties, e.g., based on interrogation using ultrasound pulses or ultrasonic energy. However, other interrogation systems may be used with a cartridge apparatus with the features described herein. Examples of other interrogation systems includes, for example, but not limited to, systems that employ cup/pin technologies (such as in the case of thromboelastography and thromboelastometry), oscillating piston to measure changes in mechanical impedance, optical sensing, fluorescence sensing, colorimetric sensing, aggregometry, resonance sensing, or electrical impedance sensing, among others.

A broad array of reagents can be utilized in the cartridge apparatus, including intrinsic pathway activators (without limitations kaolin, Hageman factor, celite, glass, ellagic acid, micronized silica etc), extrinsic pathway activators (without limitations tissue factor, recombinant tissue factor, thromboplastin, etc), other coagulation activators (without limitations thrombin, factor Xa, reptilase, ecarin, Russell's viper venom or other snake venoms, etc), platelet activators or platelet inhibitors (without limitations GPIIb/IIIa inhibitors (such as abciximab, eptifibatide, tirofiban, roxifiban, orbofiban), cytochalasin D, blebbistatin, PAR1 inhibitors or activators, PAR4 inhibitors or activators, glycoprotein IB inhibitors, TRAP, ADP, arachidonic acid, ADP inhibitors, P2Y12 inhibitors (cangrelor, ticagrelor, etc.), non-steroidal anti-inflammatory drugs, etc.), fibrinolytic function activators or fibrinolytic function inhibitors (without limitations tPA, uKA, streptokinase, TAFIa, plasmin/plasminogen, aprotinin, epsilon-aminocaproic acid, tranexamic acid, plasminogen activator inhibitor 1 (PAI1), α2-antiplasmin (α2-AP), or plasmin-antiplasmin complexes, carboxypeptidase inhibitor, etc.), and others (factor XIIIa (FXIIIa), FXIIIa inhibitors, FXIa, FXIIa, Hexadimethrine bromide (polybrene), heparinase (e.g., heparinase I), ristocetin, bivalirudin, hirudin, heparin, low molecular weight heparin, corn trypsin inhibitor, adenosine, GPRP, calcium, fibronectin, collagen, epinephrine, immuno-detection reagents, direct thrombin inhibitors, factor Xa inhibitors, reagents aimed at reversing or eliminating the effects of the new oral anticoagulants (such as the direct thrombin inhibitors and the factor Xa inhibitors), thrombomodulin, etc.). Additional non-functional reagents could also be used to preserve the functionality of the other reagents (buffers and stabilizers for lyophilization or drying, dyes, etc.).

Reagents, in some embodiments, are placed and stored in pockets located within a fluidic circuit in the cartridge apparatus but in alternative embodiments reagents can be placed and stored in fluidic channels in the fluidic circuit of the cartridge apparatus. A fluidic circuit generally refers to two or more fluidic pathways established between sample preparation and the one or more testing chambers where samples are ultimately measured.

In some embodiments, reagents are placed and stored in the cartridge apparatus in liquid forms or can be lyophilized in spheres (such as in the case of the Lyopheres™ produced by BioLyph LLC), lyophilized in films, lyophilized on the plastic surfaces, dried on the plastic surfaces, or spray coated, etc., in order to improve shelf-life stability. A person of ordinary skills in the art should recognize that these reagents are not fully inclusive and other reagents or reagent combinations that are inhibitors or activators of one or more hemostatic functions could be used in this cartridge.

The cartridge apparatus disclosed here is a component of a measurement system (e.g., a hemostasis measurement system). The measurement system (also referred to as the instrument) includes at least an interface element which couples between the cartridge apparatus and a measuring element configured to measures viscoelastic properties or mechanical properties of a sample processed within the cartridge apparatus. The measured viscoelastic properties or mechanical properties are outputted as results to a user interface. An example user interface is described in commonly assigned U.S. Pub. No. 2011/0252352 to Viola et al., which is incorporated by reference herein in its entirety.

In some embodiments, the interface element includes one or more heating and/or cooling elements.

In some embodiments, the interface element includes a fluidic manifold that facilitates connection to one or more pump elements and one or more valves.

In some embodiments, the interface element includes one or more sensors, e.g., configured to perform hemostasis measurements. The one or more sensors, in some embodiments, includes ultrasound sensors. In other embodiments, the one or more sensors includes other interrogative devices that is based on thromboelastography, thromboelastometry (e.g., a thromboelastography-based system or a thromboelastometry-based system), or that measures changes in mechanical impedance, changes in perturbation as observed via an optical-based system (e.g., having an optical sensor), fluorescence, colorimetric-based system, aggregometry-based system (e.g., having optical sensor, acoustic sensor, or electrodes that measure aggregation with the test sample), resonance-based system (e.g., having optical, acoustic, or mechanical position sensors that measures the sample when the sample is at, or near resonance), electrical impedance-based system (e.g., having electrodes configured to measure electrical impedance), or a combination thereof.

In some embodiments, the interface element includes a mechanical clamp configured to position the cartridge apparatus in a desired orientation with respect to the components (the one or more sensors, the fluidic manifold, the heating and/or cooling elements, and etc.) of the measurement system. When the interface element is interfaced with the components of the measurement system, the cartridge apparatus, in some embodiments, is driven via a series of controlled actions orchestrated by the measurement system to prepare the test sample for measurement. In some embodiments, the preparation operations include sample aspiration of a sample from a sample container (also referred to as a sample holding tube), sample heating and/or cooling, sample metering, sample mixing with reagents, and sample measurement. Each step, with reference to various embodiments, is described below. After measurements are completed, the results are output in the instrument user interface.

In some embodiments, the cartridge apparatus and its internal components are the only component that directly contact a sample to be analyzed.

In some embodiments, the cartridge includes computer readable information that can be optically or communicatively interrogated (e.g., RFID tags, computer readable medium such as flash ICs, QR codes, BAR codes, and etc.) and/or human readable information (e.g., labels).

The various embodiments described below do not utilize any active valve element in the cartridge design, but instead relies on a fluidic manifold and one or more valves placed in the instrument. Fluid is moved through the various cartridge components via pressure differential and/or gravity and/or material properties (such as in the case of hydrophobicity or hydrophilicity) and/or capillary forces.

In these embodiments, the cartridge is configured to couple with the instrument via one or more connection ports that are aligned via alignment slots. The connection ports include one or more pressure ports and one or more vent ports. However, in alternative embodiments, actuated valves (such as in the case of elastomeric valves) can be included in the cartridge design to control fluid flow. These valves are actuated, in some embodiments, by corresponding hardware and software components in the measurement system.

The surface properties and texture of the cartridge surfaces in direct contact with the sample can be optimized to promote sample adhesion and/or sample flow. In some embodiments, the testing chamber's interior surface and/or other interior surfaces of the fluidic circuit within the cartridge apparatus are plasma treated to optimize the surface energy and texture for adhesion of specific plasma proteins. In other embodiments, the testing chamber's interior surface and/or other interior surfaces of the fluidic circuit are treated with surface roughness texturing, material coating (such as in the case of gold plating), biological material coating (such as in the case of fibronectin or collagen coating, for example), raw material selection (e.g., use of specific plastic or other materials for the plate that does not require additional treatment), etc. Such treatments may be performed independently, or in conjunction with, a plasma treatment. Similarly, the cartridge materials can be selected or manipulated to achieve the desired hydrophobicity or hydrophilicity. These properties can be changed by plasma treatment or by surface coatings.

As described in more details below, the cartridge and the associated measurement system can utilize one or more sensors of one or more types (e.g., optics, pressure, ultrasound, etc.) as part of the automated operations of the cartridge. In addition, the outputs of such one or more sensor(s) can be further utilized to perform quality control checks. These checks may be performed before, during, or after cartridge testing to ensure function of one or more of the subsystems (for example, ultrasound or other interrogation system, fluidics, fluid level, clamping, cartridge positioning/orientation system, or temperature control), ensure the cartridge is functional, ensure correct sample preparation before measurements are performed or have been performed for the measurement, and may also be used to accept or reject a test result or even to abort testing before initiation of measurements.

In the discussion below, a fluidic circuit includes a metering channel, a reagent channel, a mixing zone (shown as the portion of the fluidic circuit extending between the metering channel and testing chamber), and a testing chamber positioned in series that can be individually and controllably processed within a single cartridge apparatus.

### Cartridge Input Section & Vent Pathways

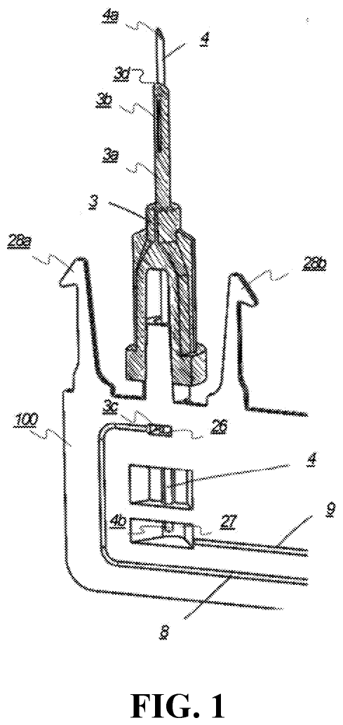

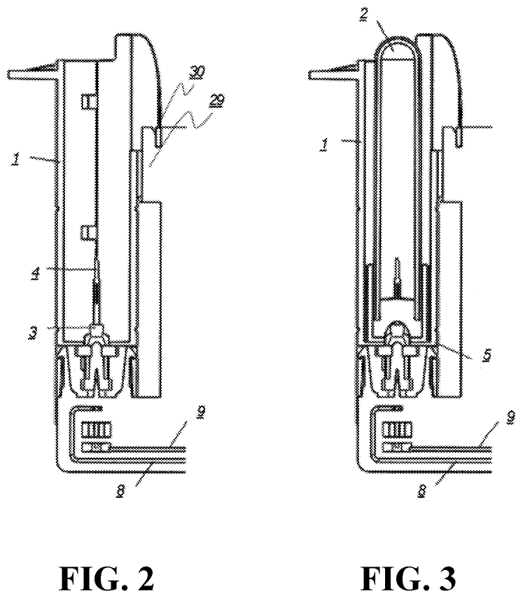

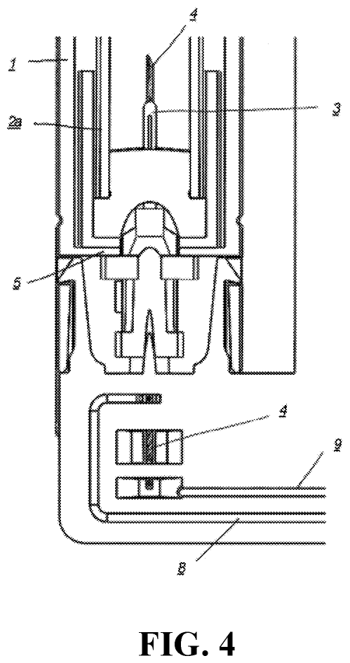

FIGS. 1, 2, 3, and 4 are schematic illustrations of an example biological sample input section of a cartridge 100 for evaluating hemostasis. Specifically, FIG. 1 shows a perspective view of an example biological sample input of a cartridge 100 for use in disposable system, in accordance with an illustrative embodiment. FIG. 2 shows a side view of the example biological sample input of FIG. 1 with a casing, in accordance with an illustrative embodiment. FIG. 3 shows a side cross-sectional view of the example biological sample input of FIG. 2 with a sample holding tube attached thereon, in accordance with an illustrative embodiment. FIG. 4 shows a detailed view of the example biological sample input of FIG. 3, in accordance with an illustrative embodiment. In alternative embodiments, the input section of the cartridge comprises a well to which fluid sample can be placed, for example, by way of a pipette or tube.

In some embodiments, and as shown in FIG. 1, the cartridge 100 has a dual connection tab 28a, 28b for coupling the cartridge 100 to a sample container guide 1 (shown in FIG. 2). As shown in FIG. 2, the sample container guide 1, when mated with the cartridge 100, aligns a sample container 2 to a sample input port 3 of the cartridge 100. The cartridge 100 also includes an alignment tab 29 that is configured to slide into an alignment groove 30 of the sample container guide 1 to further stabilize the coupling of the sample container guide 1 to the cartridge 100. The sample container guide 1 can further provide a hard stop 5 (shown in FIG. 3) to hold the sample container 2 at the appropriate height to establish fluidic communication with the cartridge 100.

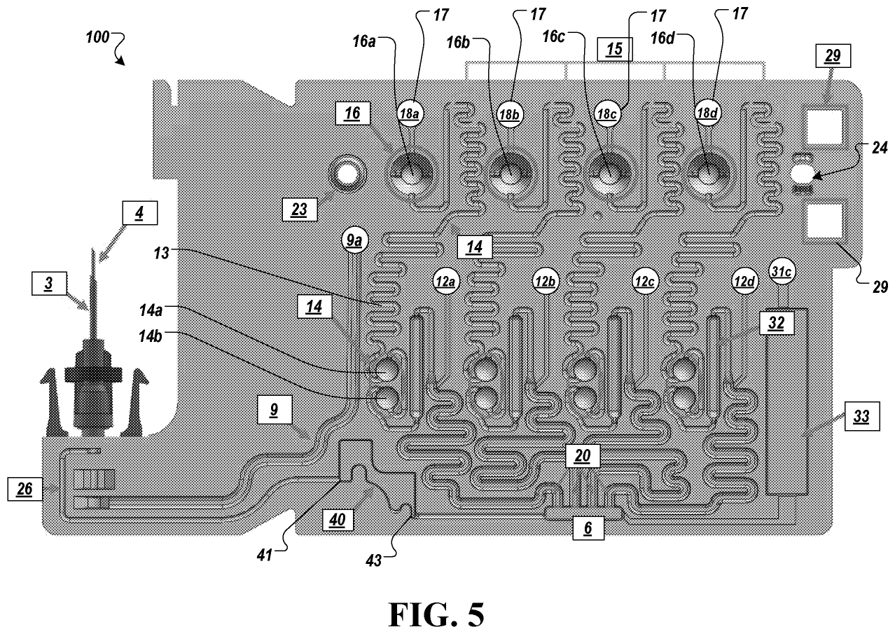

In various embodiments, the sample container 2 is an evacuated tube (also referred to herein as the sample holding tube 2) such as a BD Vacutainer™ tube, and the sample input port 3 comprises one or more needles required for sample transferring 3a and venting 4 (see FIG. 1). Though shown as concentric in the figures, the needles can be configured to be concentric, side by side, or integrated. A variety of materials can be used to form these needles, including but not limited to metal and/or plastic materials. In some embodiments, and as shown in FIG. 1, the sample transferring needle 3a includes inlets (3b and 3d) and an outlet 3c that terminates in a sample inlet 26 of the cartridge 100. The sample inlet 26 is in fluid communication with an inlet pathway 8 that leads to a fluidic manifold 6 (see FIG. 5). In some embodiments, and as shown in FIG. 1, the venting needle 4 includes an outlet 4a that is configured to terminate within the sample container 2 when attached and is spaced apart from the inlet 3d to minimize bubbles being drawn into the inlets 3b and 3d. The venting needle 4 also has an inlet 4b that terminates in a venting inlet 27 of the cartridge. The venting inlet 27 is in fluid communication with a vent pathway 9 that, in some embodiments, terminates at filter 9a (shown in FIG. 5). An alternative sample container 2 can be utilized, such as a syringe, which typically requires a luer lock connection on the cartridge 100. And, as noted above, in other embodiments, the input section of the cartridge comprises a well to which fluid sample can be placed, for example, by way of a pipette or tube.

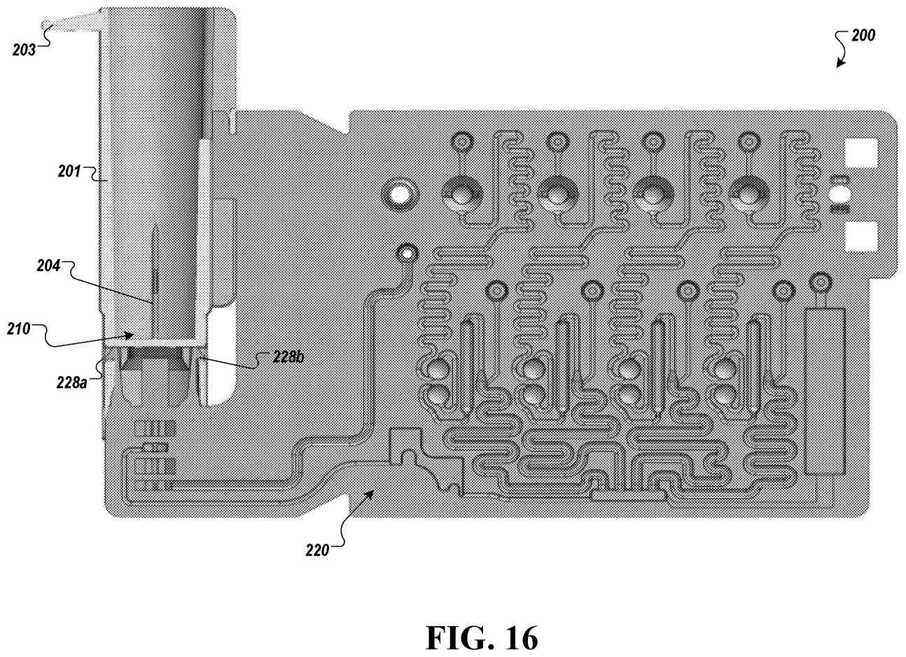

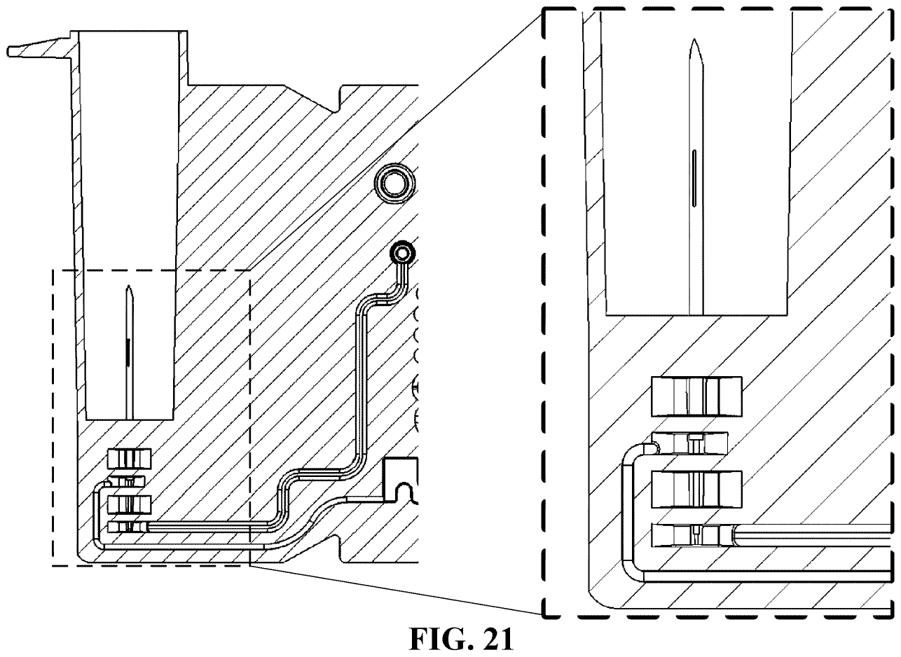

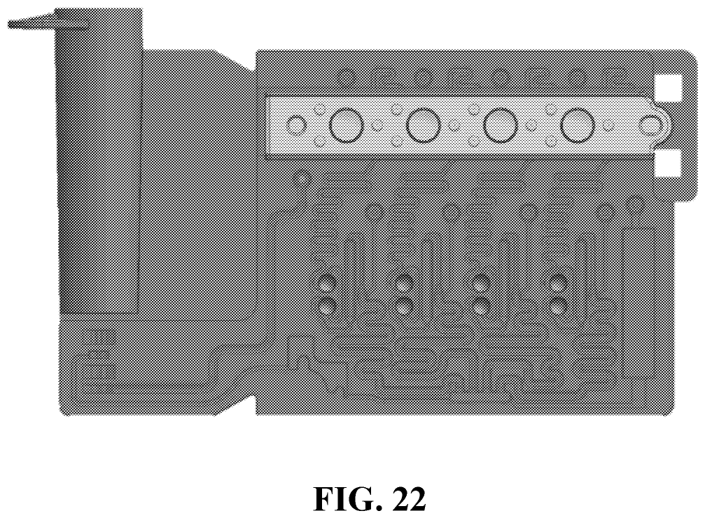

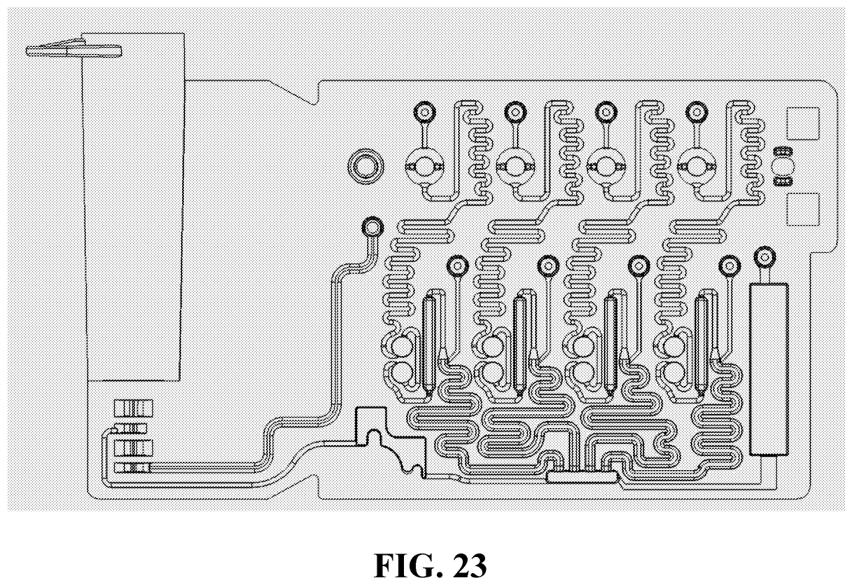

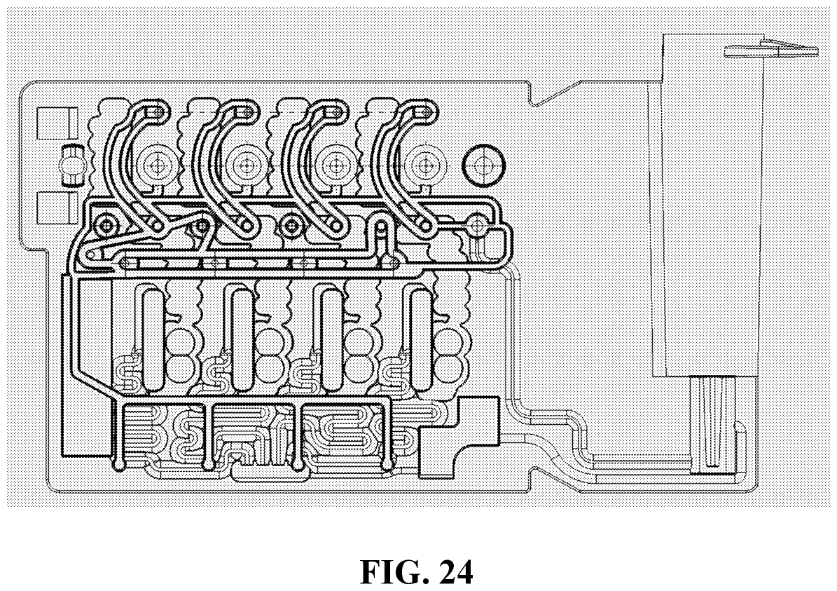

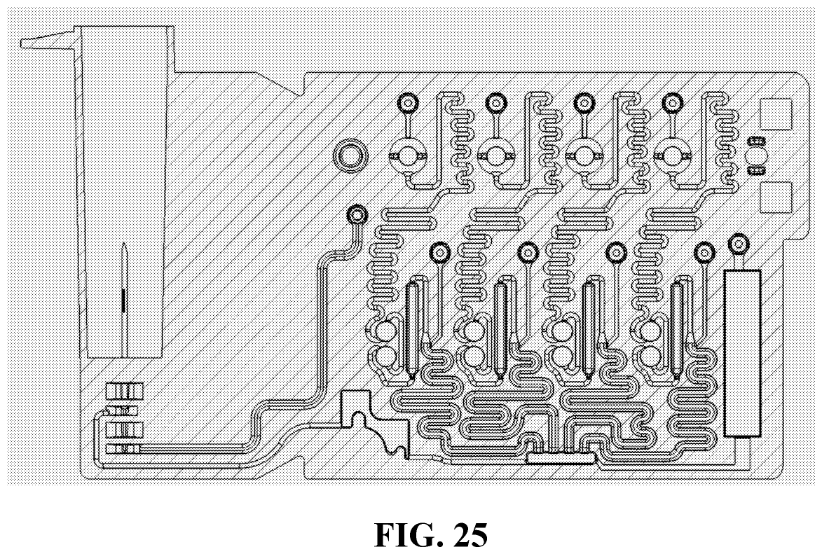

Other arrangements of the cartridge may also be used. For example, FIG. 16 depicts a schematic illustration of an input section 210 of an example cartridge 200 according to another illustrative embodiment. The cartridge 200 has an input section 210 that is for receiving the contents of a sample container (not shown) and a processing section 220 of the cartridge which is fluidically arranged to receive the sample from the input section 210. The processing section 220 of the cartridge 200 includes the relevant components used for sample processing and hemostasis testing, including, for example, a gas trap, a fluidic manifold, and a plurality of mixing and testing pathways. The input section 210 of the cartridge 200 shown in FIG. 16 also includes connection tabs 228a, 228b that can mechanically couple the cartridge 100 to a sample container guide 201. In this case, it is possible to detach and separate the sample container guide 201 from the body of the cartridge 200. This can be particularly useful in cases where different sized sample holding tubes are used to ensure a proper fit within the sample container guide 201. However, in other aspects, such as those shown in FIGS. 21-25, the sample container guide is integrally formed (e.g., as a single piece) with the body of the cartridge. Incorporating the sample container guide as an integral feature of the cartridge can reduce the number of additional components (e.g., fasteners, washers, etc.) and can thereby decrease manufacturing complexity.

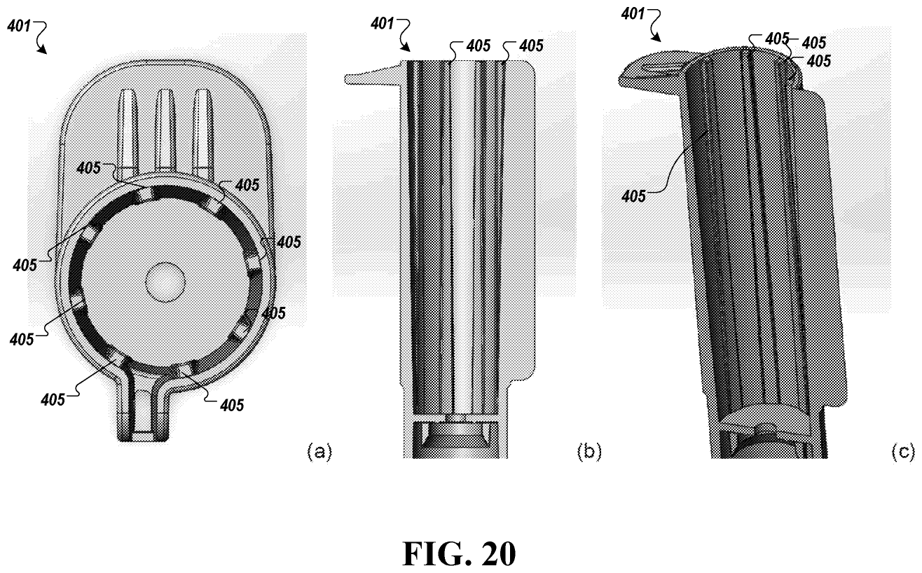

FIG. 20 provides an illustrative example of a sample container guide 401 using protrusions 405 on the inner surface of the sample container guide 401 to align a sample holding tube (not shown) to the input port. The sample container guide 401 uses a plurality of protrusions 405 in the form of rib centering features disposed on the inner wall of the sample container guide that are arranged to constrain the sample containers vertically and concentrically about the concentric needles during loading. In this manner, the constraining of the sample container guide 401 limits the amount of free-beam deflection of the needle and reduces the risk of damaging the sample while loading. Moreover, these protrusions 405 (e.g., rib centering features) allow for a substantially uniform radius down the length of the sample container guide therefore centering the sample container. These features can be thin to reduce friction along the sample container and within the mold. In some aspects, the one or more protrusions are configured to urge the sample holding tube towards a radial center of the sample container guide. The protrusions 405 shown in FIG. 20 are formed from the same material as the sample container guide 401. Using protrusions that are formed of the same material as the guide can facilitate manufacturing and allow the guide and/or other portions of the cartridge to be formed as a single piece. However, in other aspects, the protrusions include a different material than the guide. For example, the protrusions can be formed from an elastically deformable material such that insertion of the sample holding container within the guide causes the protrusions to radially deform to secure the sample holding container within the guide. Non-limiting examples of other techniques that may also be utilized include, for example, snap clips, springs, alignment channels, magnets, etc.

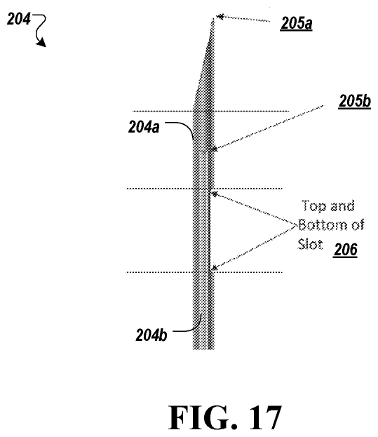

The input section 210 of the cartridge 200 also includes a needle assembly 204 that transports fluid from a sample holding tube to the processing section 220 of the cartridge 200 for hemostatic testing. FIG. 17 shows an enlarged representation of the needle assembly 204 depicted in FIG. 16. The needle assembly 204 includes an aspiration needle 204a (also called a sample transferring needle) configured to draw the sample (e.g., blood) into the cartridge 200 and a venting needle 204b configured to provide a pathway for air to enter the sample tube to enhance flow of the sample into the cartridge 200. The venting needle 204b is concentrically arranged within the aspiration needle 204a. The tip 205a of the aspiration needle 204a is beveled while the tip 205b of the venting needle 204b is blunt. The aspiration needle 204a further includes a slot 206 formed into its surface that at least partially exposes the venting needle 204b therewithin. Moreover, a tip 205b of the venting needle 204b is axially positioned between the slot 206 and a tip 205a of the aspiration needle 204a. This configuration prevents the venting needle 204b from bending during sample insertion, which eliminates septum coring that would otherwise obstruct the venting needle 204b opening. The arrangement also limits the formation of bubbles into the sample pathway by positioned the vent path opening above the aspiration needle opening.

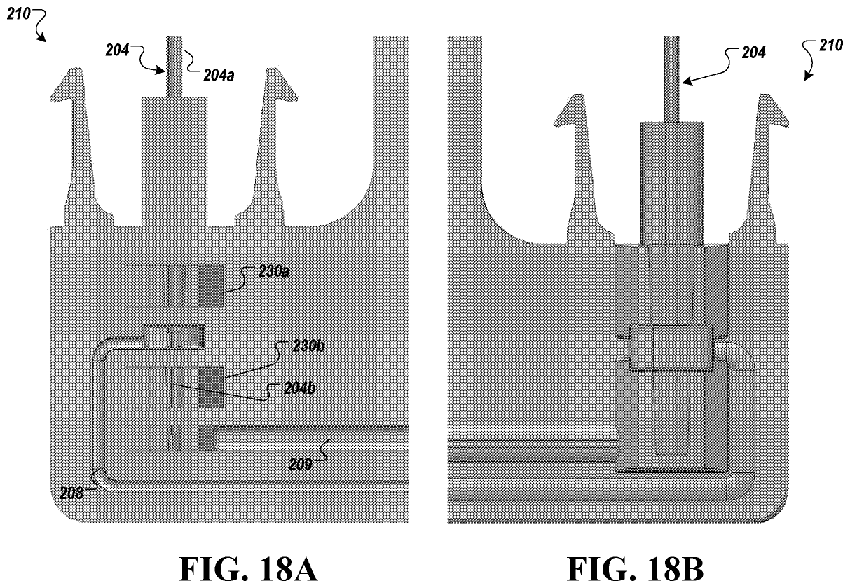

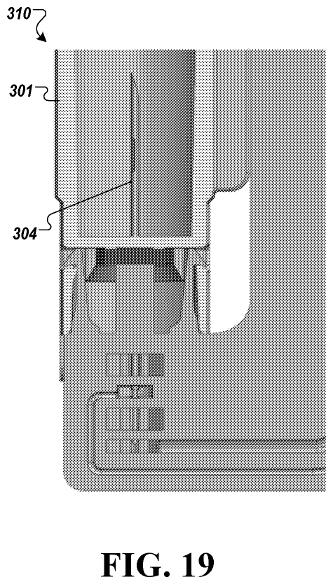

Referring now to FIGS. 18A and 18B, an enlarged front and rear views of various pathways and chambers of the input section 210. As noted previously, the needle assembly 204 includes an aspiration needle 204a and a venting needle 204b concentrically arranged therewithin. The aspiration needle and the venting needle are fixedly secured to the housing using adhesive pockets 230 (shown as 230a, 230b). The adhesive pockets include a first adhesive pocket 230a securing the aspiration needle 204a and second adhesive pocket 230b securing the venting needle 204b. Other means for securing the needles may also be used, such as mechanical fasteners and other types of couplings. The venting needle 204b is in fluid communication with a vent pathway 209 that connects the venting needle 204b to an atmosphere valve. The aspiration needle 204a is in fluid communication with an inlet pathway 208 that directs the sample to the processing section of the cartridge (see FIG. 16). FIG. 19 provides another view of an input section 310 including a needle assembly 304 disposed within a sample container guide 301.

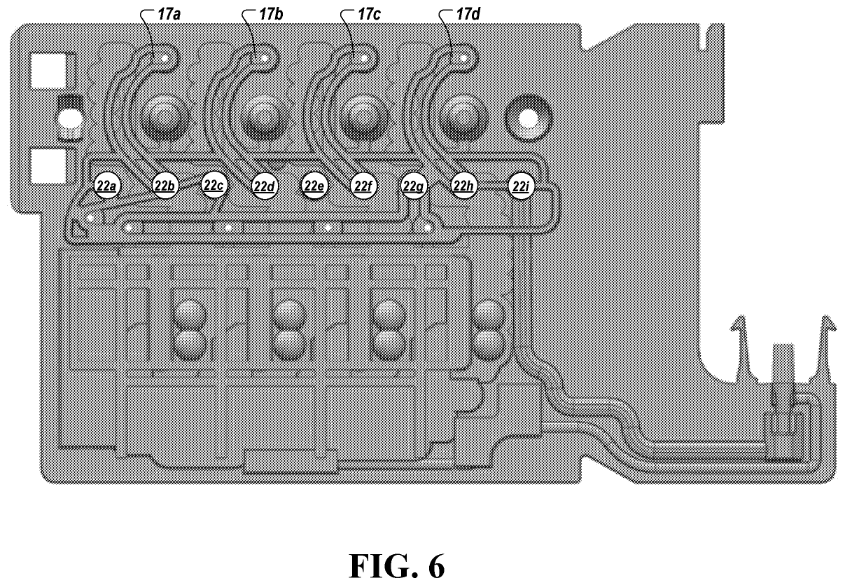

Referring now to FIGS. 5 and 6, provided are schematic illustrations of biological fluid pathways of the example cartridge 100 according to an embodiment. Specifically, FIG. 5 shows the biological fluid pathways of four testing circuits (corresponding to testing chambers 16a, 16b, 16c, and 16d, shown in FIG. 5), also referred to herein as Hemostasis testing circuits, that are located on a sample preparation plane, in accordance with an illustrative embodiment. Though shown with four testing circuits, additional circuits or less may be included, including, e.g., two, three, five, six, seven, eight, etc. Although not depicted in FIG. 5, the cartridge 100 can be further coupled to a sample holding tube 2 attached to the needle assembly to distribute the sample through flow pathways through the sample input port 3, in accordance with an illustrative embodiment.

FIG. 6 shows the back-side of the cartridge of FIG. 5 and includes an interconnection plane that interfaces to the sample preparation plane, that collectively form the biological fluid pathways for the testing circuits, in accordance with an illustrative embodiment.

As discussed above in relation to FIG. 1, in some embodiments, the venting inlet 27 is in fluid communication with a vent pathway 9. The vent pathway 9 may terminate at the filter 9a (shown in FIG. 5). The filter 9a in the first plane of fluid pathways of the cartridge 100 is in fluid communication with a vent port 22i (shown in FIG. 6) in the second plane of fluid pathways of the cartridge 100. As discussed in more detail below, cartridges 100 and 200 are configured to couple with the measurement system (also referred to herein as the instrument or testing console) via the vent port 22i to provide atmospheric pressure to vent pathway 9.

### Gas Trap Pathway

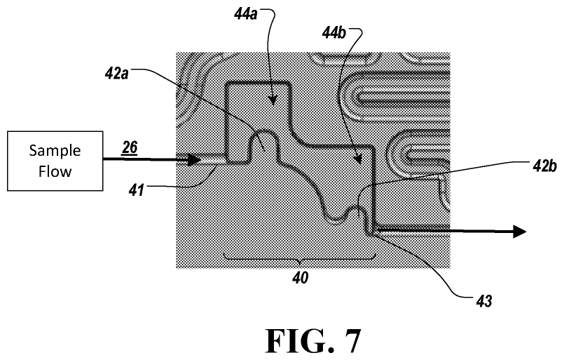

For illustrative purposes, the subsequent fluid processing and testing pathways are described only in relation to the cartridge 100 shown in FIGS. 1-6. In FIG. 1, the sample transferring needle outlet 3c terminates in a sample inlet 26 of the cartridge 100. The sample inlet 26 is in fluid communication with an inlet pathway 8. The sample inlet pathway 8 provides a fluid communication pathway between the sample inlet 26 and a gas trap 40 (shown in FIGS. 5 & 7). The term “gas trap” as described herein can include any structure suitable for separating a gas phase from a gas-fluid mixture via phase separation to provide a degassed fluid phase. Referring specifically to FIG. 7, the gas trap 40 is configured to passively facilitate separation of gases (e.g., remove air bubbles) from the liquid sample in the sample pathway before the liquid sample enters the fluidic manifold 6 and metering channels 20 (also referred as “aliquoting channels”).

Removing air from the sample ensures that the precise sample volume is metered into the metering channels, to ensure sample to reagent ratio and preventing underfill errors. Passive control of the pressure and speed of fluid flow through the gas trap 40 can be achieved by design of specific dimensions of the fluidic pathway. The fluidic manifold 6 is coupled to a mixing vent 33, connected to atmosphere to equilibrate the cartridge 100.

The gas trap 40 shown in FIG. 7 includes two impedance baffles, 42a, 42b that are positioned in-line with a respective capture pocket 44a, 44b. The impedance baffles are configured such that when a fluid contacts the impedance baffles, gases in the fluid are redirected towards the capture pockets 44a, 44b. Although the gas trap 40 shown in FIGS. 5 and 7 includes 2 impedance baffles 42a, 42b, and capture pockets 44a, 44b, other configurations and geometries may also be used. For example, the gas trap can include a single impedance baffle, or can include multiple impedance baffles (e.g., two, three, four, five, six, etc.).

During operation, a sample is pulled through the aspiration needle 3 into the sample inlet pathway 8. The sample inlet pathway 8 is in fluidic communication with the gas trap 40 at an inlet 41 of the gas trap 40, the sample contacts the first impedance baffle 42a obstructs the fluid flow and creates perpendicular velocity. This causes turbulence and pushes the sample and any air pockets upward. The capture pockets 44a, 44b each define a larger space above the impedance baffles, 42a, 42b that creates an area of high pressure and slow flow rate per the Bernoulli Principle. The pump continues to pull the sample through the narrow channel with lower pressure and faster flow. This design allows for the passive removal of any air pockets such that only fluid passes through. The second portion repeats the design of the first to add an additional safety factor optionally with an even narrower exit pathway.

### Mixing and Testing Pathway

Referring to FIG. 5 unless indicated otherwise, the outlet 43 of the gas trap 40 is in fluidic communication with the fluidic manifold 6. The fluidic manifold 6 defines a plurality of openings in fluidic communication with a respective metering channel 20. In various aspects, a volume of the fluidic manifold is smaller than a volume of the sample in the sample holding tube (e.g., 3 mL or less, 2.5 mL or less, 2 mL or less, 1.5 mL or less, 1 mL or less, or 0.5 mL or less). The metering channels 20 are in fluid communication with a backflow channel 32, which ensure that during mix down, the sample does not travel back into the metering channels 20. This prevents sample splitting, loss of sample, and any potential cross-contamination between channels. Each backflow channel 32 is configured to hold a precise volume based on pump flow rate and mix down time, plus an additional safety factor necessary to fill the testing chambers 16a-16d.

Each of the metering channels 20 is in fluid communication with a corresponding one or more reagent pocket 14 configured to house at least one lyophilized bead comprising a reagent. Two reagent pockets 14 (shown as 14a and 14b in FIG. 5 for one of the test channels) are provided. In other aspects, a single reagent pocket is used for each testing channel. In yet other embodiments, more than two (e.g., three, four, five, six, etc.) reagent pockets 14 are used for each testing channel. In some aspects, the fluid pathways (including the reagent pockets) are filled from the top to prevent backflow into the inlet. The reagent pockets 14 are in turn in fluid communication with a serpentine channel 13 (see FIG. 5). Each of the serpentine channels 13 has a first end in fluid communication with the reagent pockets and a second end that terminates at an optical detection zone 15. As discussed below, the instrument (i.e., measurement system) may optically interrogate the optical detection zone 15 of the cartridge 100 to facilitate the control of a pump that facilitates mixing of the individual aliquots with the corresponding reagent(s). Each of the serpentine channels 13 (see FIG. 5) is in fluid communication with a testing chamber 16 which in turn is in fluid communication with filter 17 (shown as 18a-18d). The filter 17 in the first plane of fluid pathways of the cartridge 100 is in fluid communication with a first end of a corresponding one of fluid channels 17a-17d (see FIG. 6) in the second plane of fluid pathways of the cartridge 100. A second end of each of the fluid communication channels 17a-17d (see FIG. 6) are in fluid communication with a corresponding pressure port 22b, 22d, 22f, and 22h (see FIG. 6). The cartridge 100 couples with instrument via the pressure ports 22b, 22d, 22f, and 22h (see FIG. 6) to supply positive and negative pressure to facilitate mixing and testing of the sample as described below.

### Sample Mixing

Referring to FIG. 5 unless indicated otherwise, each individual aliquot in the metering channels 20 is pulled into a separate reservoir or channel (a serpentine channel pathway 13 (see FIG. 5) in various embodiments) and brought into contact with the channel specific reagent, located in one (or both) of the two reagent pockets 14 (see FIG. 5). Specifically, a pump in the instrument applies negative pressure to pressure ports 22b, 22d, 22f, and 22h (see FIG. 6) to draw the sample through the reagent pockets 14 (see FIG. 5) and serpentine channel pathway 13 (see FIG. 5). The reagents and sample are kept separate from each other during metering channel 20 filling to avoid premature mixing and activation of the clotting cascade prior to the sample being heated to the requisite temperature. To this end, the precise time of when the test sample is in contact with the reagents can be measured thereby facilitating accurate and precise clot time measurements (e.g., from when mixing begins). In addition, the reagents and test samples are kept separated from one another, in some embodiments, until all channels are metered to prevent undesired siphoning of test samples from other channels or from the unprocessed sample in the fluidic pathways. The sample is aspirated through the serpentine channel 13 (see FIG. 5) until it triggers an optical sensor in the instrument (detection zone is top of serpentine channel near the optical detection zone 15 (see FIG. 5)) which closes off the channel from the pump. Mixing in the serpentine channels or zones, or region, therein can be controlled by one or more independent valves and pathways that allow individual channel control. Alternative sensor techniques could be utilized: pressure, pass through optical sensors, ultrasound detection, time, volumetric control, etc. Once all the channels' optical sensors trigger, the pump reverses and applies positive pressure to pressure ports 22b, 22d, 22f, and 22h (see FIG. 6). The positive pressure pushes the biological sample, such as blood, down the serpentine path 13 (see FIG. 5) for a designated time, or until a second set of optical sensors in the instrument is tripped (in an alternative embodiment). This process, to pull the sample up the serpentine path 13 (see FIG. 5) to the optical detection zone where it is detected by an optical sensor of the instrument and push back for a given time, repeats until full sample mixing is achieved. An illustrative example of port functionality and conditions for effectuating fluidic movement is shown in Tables 1 and 2 below.

Other sensors (e.g., impedance sensors pressure sensor, etc.), may be used. Alternatively, additional sensors may be used to detect both ends of the optical detection zone. Alternate pathway geometries, obstructions to create turbulence, cycle numbers, and cycle speed are all design alternatives that can be used with varying test types to achieve optimal results. In alternative embodiments, mixing could be achieved with one or more ferromagnetic elements (e.g., beads or bars) placed within the cartridge and controlled by the instrument.

TABLE 1
Port Function within an example cartridge

| FIG. 5 Filter Label | Function |
|---|---|
| 18d | Mix & R3 Fill (Ch. 4) |
| 31c | Mixing Vent |
| 18c | Mix & R3 Filter (Ch. 3) |
| 18b | Mix & R3 Filter (Ch. 2) |
| 12a-12d | Aliquot Fill |
| 18a | Mix & R3 Filter (Ch. 1) |
| 9a | Needle Vent |

TABLE 2
Pump Settings and End Conditions for Fluidic Steps

| Fluidic | Open Filter | Open | |
|---|---|---|---|
| Step | Ports (pump) | Vents | End Condition |
| Fill | 12a-12d | 9a | All 4 filters are clogged |
| Mix Up | 18a-18d | 31c | Optical sensors detect sample |
| Mix Down | 18a-18d | 31c | 2.0 second timeout |
| Fill R3 | 18a-18d | 31c | All 4 filters are clogged |

### Testing Chamber Filling

Referring to FIGS. 5 & 6, one or more testing chambers 16 are filled after mixing is completed. Using one or more independent valves and pathways, each testing chamber 16 is filled with a sample via the application of pressure perturbations (negative and/or positive pressure) at pressure ports 22b, 22d, 22f, and 22h. Specifically, the instrument pump will apply negative pressure to pressure ports 22b, 22d, 22f, and 22h until all of the filters are clogged in the one or more filters and cause a pressure spike to cause the instrument to turn the pump off, similar to filling the metering channels 20. As discussed above, alternative filling detection techniques could be used. The testing chambers 16 have design features such as the ridges which prevent the formation of bubbles in the testing chambers 16 during filling. Once filled, the instrument begins viscoelastic testing of the sample.

In some embodiments, the cartridge apparatus includes, at least, four independent fluidic circuits configured with different sets of reagents for measurements (and/or sample preparation) to be performed in parallel. The measurements are performed per channel of the, at least, four channels of the cartridge. The measurement, in some embodiments, include viscoelastic properties such as a sample shear modulus. The measurement, in another embodiment, includes other properties such as viscosity, elastic modulus, or any other mechanical property of the sample, or combinations thereof.

Table 3 provides an example set of reagents and measurement parameters for use in an example cartridge apparatus (e.g., apparatus 100, among others). As shown in Table 3, Channel #1 in the example cartridge apparatus is interrogated to measure clot time of the test sample in the presence of kaolin, which is an activator of the intrinsic pathway of coagulation. As shown in Table 3, Channel #2 is interrogated to measure clot time of the test sample in the presence of kaolin and in further presence of heparinase I, which is a neutralizer of the anticoagulant heparin. As shown in Table 3, Channel #3 is interrogated to measure overall clot stiffness of the test sample in the presence of i) thromboplastin, which is an activator of the extrinsic pathway of coagulation, and ii) polybrene, which is a neutralizer of the anticoagulant heparin. As shown in Table 3, Channel #4 is interrogated to measure clot stiffness of the test sample with the same reagents as channel #3, but with the addition of abciximab (e.g., Clotinab® and/or ReoPro®), which is an inhibitor of platelet aggregation/contraction. As shown in Table 3, when the assay is configured to operate with citrated whole blood samples, calcium is added to all the reagent formulations.

TABLE 3
Reagents utilized in a preferred embodiment

| Channel # | Reagents | Measurement (units) |
|---|---|---|
| 1 | Kaolin, calcium, buffers and stabilizers | Clot time (Seconds) |
| 2 | Kaolin, heparinase I, calcium, | Clot time (Seconds) |
| | buffers and stabilizers | |
| 3 | Thromboplastin, polybrene, calcium, | Clot stiffness |
| | buffers and stabilizers | (hectoPascals) |
| 4 | Thromboplastin, polybrene, | Clot stiffness |
| | abciximab (and/or cytochalasin D), | (hectoPascals) |
| | calcium, buffers and stabilizers | |

Table 4 provides an additional example set of reagents and measurements for use in an example cartridge apparatus (e.g., apparatus 100, among others). As shown in Table 4, channel #2 includes an extrinsic pathway activator with inhibition of fibrinolysis by tranexamic acid (TXA). In addition to the measurements previously presented in Table 3, channels #2, channel #3, and channel #4 are interrogated to also measure clot stiffness changes, which, for example, can be related to the fibrinolytic process. In some embodiments, other channels can include reagents that inhibit fibrinolysis and can also be interrogated to measure clot stiffness changes. For example, channel #4 could also include TXA or other fibrinolysis inhibitors in order to measure clot stiffness in the absence of fibrinolysis.

TABLE 4
Reagents utilized in a preferred embodiment

| Channel # | Reagents | Measurement (units) |
|---|---|---|
| 1 | Kaolin, calcium, buffers and stabilizers | Clot time (Seconds) |
| 2 | Thromboplastin, polybrene, calcium, | Clot stiffness |
| | tranexamic acid, buffers and stabilizers | (hectoPascals) |
| | | and Clot |
| | | stiffness change |
| 3 | Thromboplastin, polybrene, calcium, | Clot stiffness |
| | buffers and stabilizers | (hectoPascals) |
| | | and clot |
| | | stiffness change |
| 4 | Thromboplastin, polybrene, | Clot stiffness |
| | abciximab (and/or cytochalasin D), | (hectoPascals) |
| | calcium, buffers and stabilizers | and clot |
| | | stiffness change |

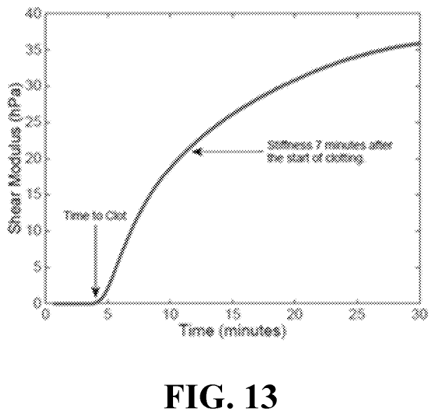

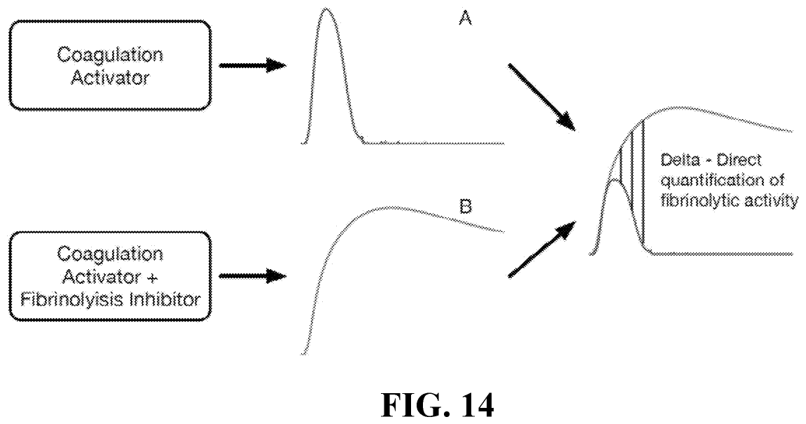

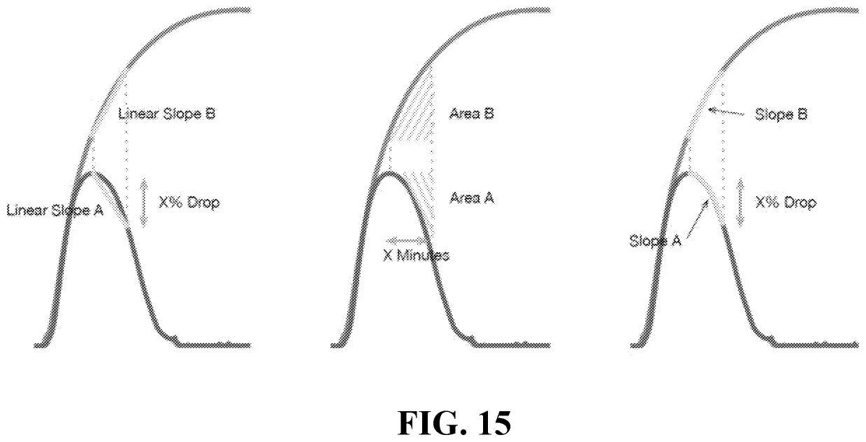

In some embodiments, clot time and clot stiffness are measured by analyzing a shear modulus (clot stiffness) versus time curve that is generated within each measurement channel in the cartridge. FIG. 13 shows an example shear module versus time curve, in accordance with an illustrative embodiment. FIG. 14 illustrate shear modulus curves obtained with an activator of coagulation and with and without a fibrinolysis inhibitor. A differential comparison of these curves can provide information about the fibrinolytic activity of the sample. It should also be noted that other metrics may be measured or derived from shear modulus curves, such as those shown in FIG. 15. Clot time may be determined by identifying when the clot stiffness meets or exceeds a threshold value, or when the first or higher derivative of such property being measured meets or exceeds a threshold value, or at the point of maximum acceleration in the rate of clot stiffness, or some combination of the above methods. Clot stiffness may be estimated by the clot stiffness at a fixed time after clot time, or the maximum overall clot stiffness measured within some time limit, or the clot stiffness at the point of maximum rate of change in clot stiffness, or some combination of the above methods. Similar methods can also be applied to measure the effects of fibrinolysis (i.e., clot dissolution) and the corresponding reduction in clot stiffness. In some embodiments, clot stiffness changes can be calculated as the percentage drop in clot stiffness over a fixed time window, as a rate of change of clot stiffness over time, as area under or over the clot stiffness vs time curve within a predefined time window, as the time required to achieve a predefined drop in clot stiffness, or combinations thereof. Similar curves and similar measurements to those just described can be formed by plotting the Young's modulus, viscosity, or other viscoelastic property of the sample being measured.

TABLE 5
Parameters reported from measurement of the preferred
embodiments discussed in relation to Table 3.

| Hemostatic | | | |
|---|---|---|---|
| Index | Units | Description | Measurement |
| Clot Time | Seconds | Clot time in citrated | Clot time measured from channel #1 |
| | (sec) | whole blood | with kaolin activation (intrinsic |
| | | | pathway) |
| Heparinase | Seconds | Clot time in citrated | Clot time measured from channel #2 with |
| Clot Time | (sec) | whole blood with | kaolin activation and heparinase I |
| | | heparin neutralization | |
| Clot Stiffness | hectoPascals | Stiffness of the whole | Clot stiffness measured from channel |
| | (hPa) | blood clot | #3 with thromboplastin activation |
| | | | (extrinsic pathway) and polybrene |
| Fibrinogen | hectoPascals | Contribution of | Clot stiffness measured from |
| Contribution | (hPa) | functional fibrinogen | channel#4 with thromboplastin |
| | | to clot stiffness | activation, polybrene, and abciximab |
| Clot Time Ratio | Unitless | Assessment of | Calculated ratio of clot time values |
| | | residual heparin | from channels #1 and #2 |
| | | anticoagulation | |
| Platelet | hectoPascals | Contribution of | Calculated from subtraction of the clot |
| Contribution | (hPa) | platelet activity to | stiffness values from channels #3 and |
| | | clot stiffness | #4 |

A person of ordinary skills in the art should recognize that clot time and clot stiffness can be estimated using a number of methodologies and criteria. Clot times and clot stiffness values obtained from the, at least, four channels/measurements may be combined to provide, at least, six parameters can depict a functional status of the patient's hemostatic system. The indexes are summarized in Table 5. Relationship between results (clot time, clot stiffness, clot stiffness change, etc.) from different channels may be verified to be within expected ranges as additional quality control checks to verify instrument, cartridge, and sample function.

In other embodiments, other reagents can be used, and other hemostatic indexes or output parameters can be obtained such as in the case of a fibrinolytic index, indexes corresponding to the functionality of anti-platelet treatments, indexes corresponding to the functionality of anti-coagulation treatments, etc.

For example, one or more fibrinolysis indexes could be formed using the clot stiffness changes measured in any of the channels presented in Table 4, but preferably channels #3 and #4. Alternatively, a fibrinolysis index could be formed by differential combination of the clot stiffness changes measured in channels #2 and channel #3 presented in Table 4. Such combination could be in the form of a ratio, a difference, or combinations thereof. One of the benefit of using a combination of clot stiffness changes measured with and without an anti-fibrinolytic reagent is the ability to mitigate the interfering effects of non-fibrinolysis driven reductions in clot stiffness values. In some embodiments, TXA or other fibrinolysis inhibitor reagent can be included in both channel #2 and channel #4 of the example cartridge of Table 4. With such modifications the parameters Clot Stiffness, Platelet Contribution, and Fibrinogen Contribution could be derived without the influence of fibrinolysis by combination of the clot stiffness measurements obtained in channel #2 and channel #4.

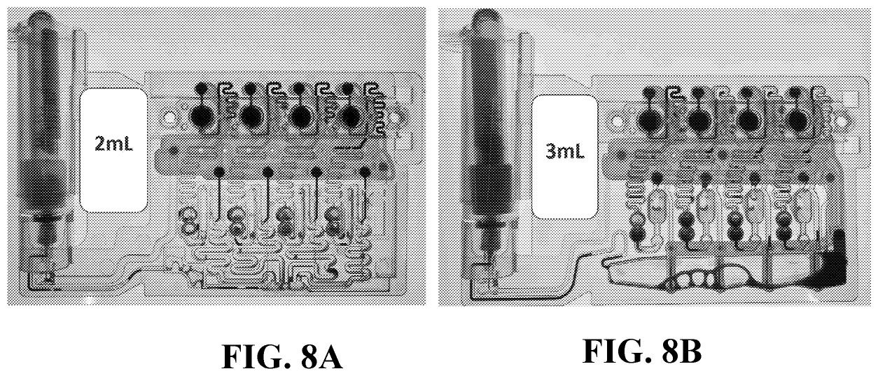

As discussed above, an example user interface is described in commonly assigned U.S. Pub. No. 2011/0252352 to Viola et al., which is incorporated by reference herein in its entirety. The example user interface may be used to display the measured hemostatic indexes as discussed in relation to Tables 5 and 6, among other parameters. FIGS. 8A-8B show an example user interface illustrating various hemostatic parameters (CT=clot time; CTH=clot time with heparinase; CTR=clot time ratio; CS=clot stiffness; PCS=platelet contribution to clot stiffness; and FCS=fibrinogen contribution to clot stiffness). FIG. 8A depicts a dial display showing parameters within the normal reference range while FIG. 8B shows a dial display for a test sample having several parameters outside the normal window.

TABLE 6
Parameters reported from measurement of the preferred
embodiments discussed in relation to Table 4.

| Hemostatic | | | |
|---|---|---|---|
| Index | Units | Description | Measurement |
| Clot Time | Seconds | Clot time in | Clot time measured from channel #1 |
| | (sec) | citrated whole | with kaolin activation (intrinsic |
| | | blood | pathway) |
| Clot Stiffness | hectoPascals | Stiffness of the | Clot stiffness measured from channel |
| | (hPa) | whole blood clot | #3 with thromboplastin activation |
| | | | (extrinsic pathway) and polybrene |
| Fibrinogen | hectoPascals | Contribution of | Clot stiffness measured from channel |
| Contribution | (hPa) | functional | #4 with thromboplastin activation, |
| | | fibrinogen to clot | polybrene, and abciximab |
| | | stiffness | |
| Platelet | hectoPascals | Contribution of | Calculated from subtraction of the clot |
| Contribution | (hPa) | platelet activity | stiffness values from channels #3 and |
| | | to clot stiffness | #4 |
| Clot | % or | Clot stiffness | Changes (% or rate of change) in clot |
| Stiffness | hPa/sec | change over | stiffness measured from channels #2 |
| Change | or sec | time | and #3 |
| Clot | % or | Differential rate | Differential comparison of clot |
| Reduction | hPa/sec, | of clot stiffness | stiffness change measured in channels |
| Differential | or no | changes with | #2 and #3. |
| or Clot | units | and without | |
| Stability to | | anti-fibrinolytic | |
| Lysis | | | |

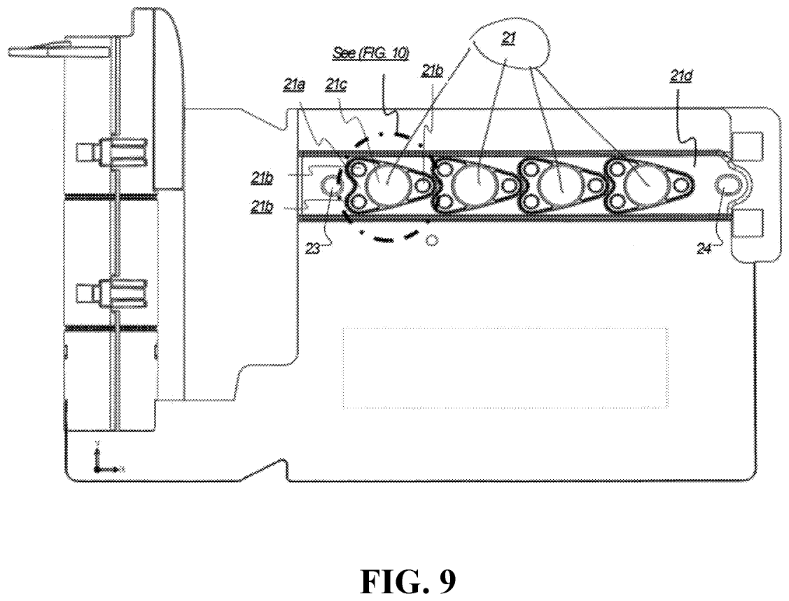

As noted before, in various embodiments, the testing chambers 16 are shaped to facilitate ultrasound testing of viscoelastic properties of the sample, but alternative geometries can also be implemented to facilitate other types of testing. Such an ultrasound testing system is described in commonly assigned U.S. Pat. No. 9,726,647 and U.S. Pub. No. 2016/0139159, both of which are hereby incorporated by reference in their entirety. Ultrasound transducers in the measuring system connect with the testing chambers 16 of the cartridge 100 via compliant and deformable elastomers 21 (FIG. 9) which are affixed to a testing block 21d on the cartridge 100.

Example elastomeric materials optionally include, Dynaflex D3202, Versaflex OM 9-802CL, Maxelast 54740, RTP 6035, Versaflex CL2003X, among others. Referring now to FIG. 9 unless indicated otherwise, the testing block 21d is aligned with the testing chambers 16 (see FIG. 5) via alignment slots 23 and 24 on the cartridge 100. Referring still to FIG. 9, the elastomers 21 may be affixed to the testing block 21d via a flange 21a on the elastomers 21. The flange 21a may have a plurality of alignment holes 21b that may receive corresponding alignment pegs (not shown) from the testing block 21d. The soft elastomers 21 may also each include a lens 21c that focuses ultrasound energy within the sample at the testing chambers 16.

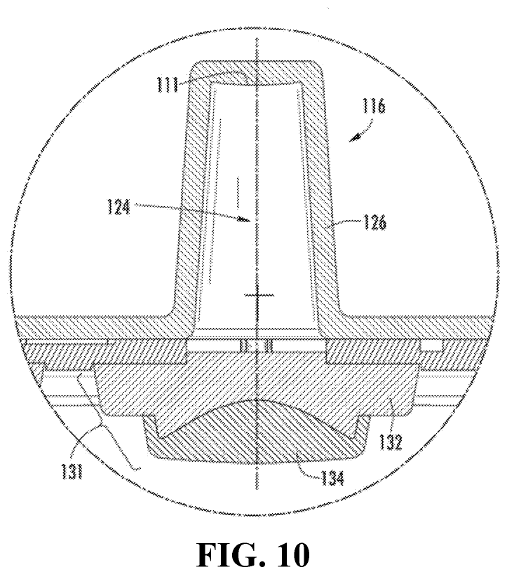

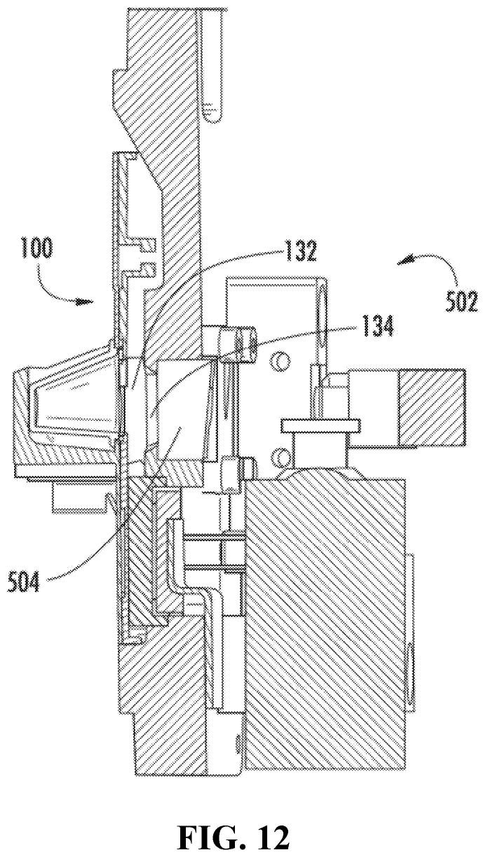

As described in U.S. Pat. No. 9,272,280, which is incorporated by reference herein in its entirety, in various embodiments, the consumable cartridge contains a lens assembly that focuses ultrasound energy within the sample that can be used to generate streaming and mixing. The lens assembly, or sound focusing assembly, is designed using a soft material, such as a thermoplastic elastomer 134 (previously referred to as 21), in conjunction with a rigid substrate 132 (e.g., formed of testing block 21d), such as polystyrene as shown in FIGS. 10, 11, and 12. This combination provides a dry ultrasound coupling that does not require the use of any fluid or gel couplant. Note that the same lens and ultrasound driver used for hemostasis measurement can be used in this matter to provide mixing. Increasing acoustic energy for mixing can be delivered by, for example, increasing pulse length, pulse amplitude or pulse repetition frequency.

Referring now to FIG. 10, a top cross-sectional view of the testing chamber 116 (referred to previously as testing chamber 16) is shown. To seal each testing chamber, e.g. testing chamber 116, a lens assembly 131 includes a rigid substrate 132 and a couplant 134 that can be positioned at the back end of each testing chamber.

Referring still to FIG. 10, each couplant 134 comprises an elastomeric material. Optionally, the elastomeric material is a thermoplastic elastomer (TPE). Example elastomeric materials optionally include, Dynaflex D3202, Versaflex OM 9-802CL, Maxelast 54740, RTP 6035, Versaflex CL2003X, among others. Optionally the couplant is over-molded to the rigid substrate. Optionally the couplant is mechanically anchored to the rigid substrate.

Referring still to FIG. 10, between each couplant 134 and the open space of each testing chamber is a rigid substrate 132. The rigid substrate and the couplant form an interface that focuses ultrasound transmitted (e.g. lens assembly) by an ultrasonic transducer into the testing chamber's open space and onto any biological fluid and/or reagents in the testing chamber. The rigid substrate of the lens can comprise a material which allows sound to pass and that can act to focus ultrasound at some level within the space. Optionally, the rigid substrate comprises a styrene.

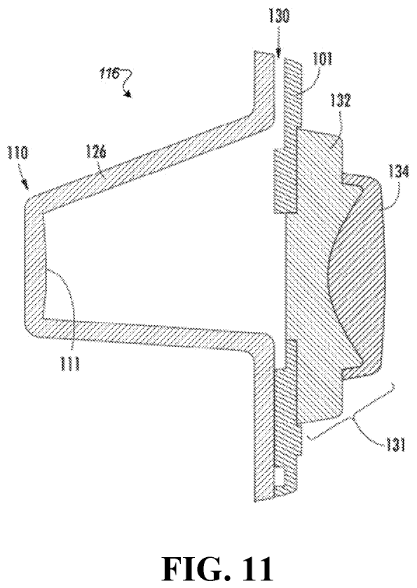

Referring now to FIG. 11, The lens assembly may be glued or welded to the surface 101 of the testing block 21d (shown in FIG. 11 as element 132) to secure the lens in place in an orientation that allows the desired focusing of sound. Alternatively, the lens assembly is optionally manufactured together with the surface 101 of the testing block 21d. In this regard, the rigid substrate 132 can be molded with the surface 101 of the testing block 21d and the couplant 134 can be overmolded or mechanically anchored on the rigid substrate. A wide variety of materials can be used to construct the device. For example, plastics can be used for single use, disposable cartridges.

Referring still to FIG. 11, each of the testing chambers 116 can have a lens assembly positioned over the large opening of each testing chamber's open space. In this way, each testing chamber can be separately interrogated by focused ultrasound.

Referring still to FIG. 11, when placed in the instrument, the couplant 134 can be placed in acoustic communication with a transducer for supplying ultrasound through the lens assembly and into a testing chamber 116. Optionally, an intermediate layer of an acoustically permeable material is positioned between an ultrasonic transducer and the couplant. For example, an intermediate layer or block of Rexolite® or TPX® can be used. The intermediate layer can be forced against the couplant and can be in acoustic contact with the transducer.

Referring still to FIG. 11, sound generated by a transducer passes through the intermediate layer, through the couplant, through the rigid substrate, and is focused within the biological sample, such as blood, and reagent in the testing chamber. Some of the sound directed into testing chamber contacts the distal interior surface 111 of the testing chamber, which is defined by the surface 126. Optionally, the surface is polystyrene. The distal interior surface has a known geometry and is positioned at a known distance from the ultrasound source. The distal interior surface 111 is used as a calibrated reflector, which is used to estimate the speed of sound and attenuation of sound in a testing chamber at base line and during the process of clot formation and clot dissolution. These measurements can be used, for example, to estimate hematocrit of the subject along with the indexes of hemostasis. The sound generated by the transducer can be focused within the biological sample in a testing chamber using a parabolic mirror that is coupled to the biological sample using an elastomer.

Other example cartridge apparatus and measurement system, and methods thereof, are described in U.S. Pat. No. 9,031,701; U.S. Provisional Appl. No. 61/443,084; U.S. Pat. Nos. 9,272,280; 9,410,971; U.S. Provisional Appl. No. 61/443,088; U.S. Publication No. 2011/0252352; published PCT Publication No. WO2011/127436; U.S. Publication No. 2012/0294767; U.S. Pat. Nos. 7,892,188; 8,740,818; U.S. Publication No. 2016/0274067, and U.S. Pat. No. 11,366,093, each of which is incorporated by reference herein in its entirety.

As noted, the cartridge and features described herein can be modified for use with other types of measurement systems such as thromboelastography-based systems, thromboelastometry-based systems, optical-based systems, fluorescence-based systems, colorimetric-based systems, aggregometry-based systems, resonance-based system, and an electrical impedance-based system, among others.

Many modifications and other embodiments of the invention set forth herein will come to mind to one skilled in the art to which this invention pertains having the benefit of the teachings presented in the foregoing description. Therefore, it is to be understood that the invention is not to be limited to the specific embodiments disclosed and that modifications and other embodiments are intended to be included within the scope of the appended claims.

Although specific terms are employed herein, they are used in a generic and descriptive sense only and not for purposes of limitation.

As used in the claims, the term “first”, “second”, and “third” are provided merely as labels and do not intended to connote a sequence.
Embodiment 1: An apparatus comprising: a housing; an input port integrally formed with the housing that is structurally configured to receive contents of a sample holding tube; a gas trap in fluidic communication with the input port, wherein the gas trap is structurally configured to receive a liquid sample from the input port and to facilitate separation of gases from the liquid sample; and a fluidic manifold in fluidic communication with the gas trap, the fluidic manifold being configured to receive the sample from the gas trap and to direct the degassed sample into two or more fluidic circuits downstream to the fluidic manifold, wherein each of the two or more fluidic circuits comprises i) a reagent channel in fluidic communication with the fluidic manifold, wherein the degassed sample is introduced to one or more reagents located in a corresponding fluidic circuit to form a mixed sample and ii) a testing chamber in fluidic communication with the reagent channel, the testing chamber being structurally configured for interrogation by a measurement system configured to determine at least one viscoelastic property of the mixed sample.
Embodiment 2: The apparatus of Embodiment 1, wherein each of the two or more fluidic circuits further comprises a metering channel positioned between the fluidic manifold and the reagent channel, wherein each metering channel is configured to receive a metered sample from a respective output of the fluidic manifold.
Embodiment 3: The apparatus of any one of Embodiments 1-2, wherein each respective reagent channel comprises one or more pockets configured to house at least one lyophilized bead comprising the one or more reagents.
Embodiment 4: The apparatus of any one of Embodiments 1-3, wherein the input port forms a part of a needle assembly structurally configured to establish fluidic communication and evacuate contents of the sample holding tube.
Embodiment 5: The apparatus of Embodiment 4, wherein the needle assembly comprises the input port and a second port, wherein the second port is configured to vent a liquid or gas into the sample holding tube so as to promote evacuation of the contents therein.
Embodiment 6: The apparatus of any one of Embodiments 1-5, wherein the input port is structurally configured to couple to a luer lock configured to connect to the sample holding tube.
Embodiment 7: The apparatus of any one of Embodiments 4-6, wherein the needle assembly comprises an aspiration needle and a venting needle, wherein the venting needle is concentrically arranged within the aspiration needle.
Embodiment 8: The apparatus of Embodiment 7, wherein the aspiration needle comprises a slot that at least partially exposes the venting needle therewithin.
Embodiment 9: The apparatus of Embodiment 8, wherein a tip of the venting needle is axially positioned between the slot and a tip of the aspiration needle.
Embodiment 10: The apparatus of any one of Embodiments 7-9, wherein a tip of the aspiration needle is beveled.
Embodiment 11: The apparatus of any one of Embodiments 7-10, wherein a tip of the venting needle is blunt.
Embodiment 12: The apparatus of any one of Embodiments 7-11, wherein the aspiration needle and/or the venting needle are fixedly secured to the housing using one or more adhesive pockets.
Embodiment 13: The apparatus of Embodiment 12, wherein the one or more adhesive pockets comprises a first adhesive pocket securing the aspiration needle and second adhesive pocket securing the venting needle.
Embodiment 14: The apparatus of any one of Embodiments 1-13, further comprising a sample container guide shaped to receive the sample holding tube and to align the sample holding tube to the input port.
Embodiment 15: The apparatus of Embodiment 14, wherein the sample container guide is integrally formed with the input port.
Embodiment 16: The apparatus of Embodiment 14, wherein the sample container guide is separately attachable to the input port.
Embodiment 17: The apparatus of any one of Embodiments 14-16, wherein an inner surface of the sample container guide comprises one or more protrusions to align the sample holding tube to the input port.
Embodiment 18: The apparatus of Embodiment 17, wherein the one or more protrusions are configured to urge the sample holding tube towards a radial center of the sample container guide.
Embodiment 19: The apparatus of any one of Embodiments 2-18, wherein at least a portion of the metering channels comprise a shape and/or material optimized to facilitate heating and/or cooling of the sample to, or near, a desired temperature.
Embodiment 20: The apparatus of Embodiment 19, wherein the metering channel comprises a serpentine-shaped conduit.
Embodiment 21: The apparatus of any one of Embodiments 2-20, wherein at least a portion of the metering channels are configured to mate with a corresponding thermal regulating system to condition the received sample to a desired temperature.
Embodiment 22: The apparatus of Embodiment 21, wherein at least a portion of the metering channels are in physical proximity with a sensor of the measurement system configured to determine a temperature.
Embodiment 23: The apparatus of any one of Embodiments 1-22, wherein each of the two or more fluidic circuits comprises a third set of fluid pathways in fluidic communication between a respective reagent channel and respective testing chamber, wherein at least a portion of third set of fluid pathways are arranged as a serpentine-shaped conduit.
Embodiment 24: The apparatus of any one of Embodiments 2-23, wherein each of the reagent channels is connected to a respective first pressure port, wherein pressure when applied to the first pressure port causes the filling of the metering channel through the fluidic manifold.
Embodiment 25: The apparatus of Embodiment 24, comprising a filter positioned within the first pressure port, wherein the filter is configured to allow air to move through the first pressure port but prevent fluid from moving there through.
Embodiment 26: The apparatus of Embodiment 25, wherein the fluidic manifold is further connected to a vent port, wherein the vent port is configured to be closed while the sample is metered into an aliquot in the metering channel and further configured to be open to atmospheric pressure after the sample is metered into the aliquot in the metering channel.
Embodiment 27: The apparatus of any one of Embodiments 23-26, wherein the serpentine-shaped conduits form a serpentine reservoir between the testing chambers and the reagent channels, and wherein a substantial portion of the contents of a sample holding tube is directed through the serpentine-shaped conduits.
Embodiment 28: The apparatus of Embodiment 27, wherein the metered sample is alternately directed, for each of the two or more fluidic circuits, between a first position in a fluidic circuit and a second position in the fluidic circuit, wherein a path between the first position and second portion includes at least a portion of the serpentine-shaped conduit.
Embodiment 29: The apparatus of Embodiment 28, wherein each of the testing chambers is connected to a second pressure port, wherein when pressure is applied to the second pressure port the test sample flows toward the testing chamber through a respective serpentine-shaped conduit.
Embodiment 30: The apparatus of Embodiment 29, wherein when pressure is applied to the second pressure port in a reversed direction, the test sample flows away from the testing chamber through the respective serpentine-shaped conduit.
Embodiment 31: The apparatus of any one of Embodiments 29-30, wherein the serpentine-shaped conduit includes an optical detection zone.
Embodiment 32: The apparatus of any one of Embodiments 2-31, wherein each of the two or more fluidic circuits further comprise a mixing zone between the testing chamber and the metering channel, the mixing zone comprising one or more ferromagnetic elements therein.
Embodiment 33: The apparatus of any one of Embodiments 1-32, wherein at least one of the two or more fluidic circuits comprises one or more quality testing ports, wherein the one or more quality testing ports is configured to be sensed optically or electrically.
Embodiment 34: The apparatus of any one of Embodiments 1-33, wherein the testing chamber comprises a lens configured to direct ultrasonic pulses generated by the measurement system into the testing chamber.
Embodiment 35: The apparatus of any one of Embodiments 1-34, wherein a volume of the sample in the sample holding tube is 3 mL or less, 2.5 mL or less, 2 mL or less, or from 1.5 mL to 2.5 mL, or from 1.8 mL to 2.0 mL.
Embodiment 36: The apparatus of any one of Embodiments 1-35, wherein the gas trap comprises one or more capture pockets positioned above a fluid path of the sample through the gas trap, wherein the capture pockets are configured to collect and retain gases from the sample.
Embodiment 37: The apparatus of any one of Embodiments 1-36, wherein the gas trap comprises one or more impedance baffles positioned in-line of the one or more capture pockets, the impedance baffles configured such that when a fluid contacts the impedance baffles, gases in the fluid are redirected towards the capture pockets.
Embodiment 38: The apparatus of any one of Embodiments 1-37, wherein an inlet of the gas trap is disposed above an outlet of the gas trap.
Embodiment 39: The apparatus of any one of Embodiments 1-38, wherein at least one of the reagents located in the two or more fluidic circuits is selected from the group consisting of an intrinsic pathway activator, an extrinsic pathway activator, and a coagulation activator.
Embodiment 40: The apparatus of any one of Embodiments 1-39, wherein the one or more reagents includes one or more reagents selected from the group consisting of a platelet activator, a platelet inhibitor, and an agonist.
Embodiment 41: The apparatus of any one of Embodiments 1-40, wherein a first set of one or more reagents comprise an intrinsic pathway activator, wherein a second set of one or more reagents comprises an extrinsic pathway activator and a fibrinolysis inhibitor, wherein a third set of one or more reagents comprises an extrinsic pathway activator, and wherein a fourth set of one or more reagents comprises an extrinsic pathway activator and a platelet inhibitor.
Embodiment 42: The apparatus of any one of Embodiments 1-41, wherein the measurement system is selected from the group consisting of a sonorheometry-based system, thromboelastography-based system, a thromboelastometry-based system, an optical-based system, a fluorescence-based system, a colorimetric-based system, an aggregometry-based system, a resonance-based system, and an electrical impedance-based system.
Embodiment 43: An apparatus comprising: a housing; an input port integrally formed with the housing that is structurally configured to receive contents of a sample holding tube; a fluidic manifold in fluidic communication with the input port, the fluidic manifold being configured to receive the sample from the input port and to direct a metered sample into each of two or more fluidic circuits downstream to the fluidic manifold, wherein each of the two or more fluidic circuits comprises i) a metering channel including a serpentine-shaped conduit in fluid communication with the fluidic manifold, wherein the metering channel is configured to receive the metered sample from a respective output of the fluidic manifold, ii) a reagent channel in fluidic communication with the metering channel, wherein the metered sample is introduced to one or more reagents located in a corresponding fluidic circuit to form a mixed sample, and iii) a testing chamber in fluidic communication with the reagent channel, the testing chamber being structurally configured for interrogation by a measurement system configured to determine at least one viscoelastic property of the mixed sample.
Embodiment 44: An apparatus comprising: a housing; an input port integrally formed with the housing that is structurally configured to receive contents of a sample holding tube; a fluidic manifold in fluidic communication with the input port, the fluidic manifold being configured to receive the sample from the input port and to direct a metered sample into each of two or more fluidic circuits downstream to the fluidic manifold, wherein each of the two or more fluidic circuits comprises i) a metering channel in fluid communication with the fluidic manifold, wherein the metering channel is configured to receive the metered sample from a respective output of the fluidic manifold, ii) a reagent channel in fluidic communication with the fluidic manifold, wherein the metered sample is introduced to one or more reagents located in a corresponding fluidic circuit to form a mixed sample and iii) a testing chamber in fluidic communication with the reagent channel, the testing chamber being structurally configured for interrogation by a measurement system configured to determine at least one viscoelastic property of the mixed sample, wherein the apparatus is configured to receive a sample of less than 3 mL, less than 2.5 mL, less than 2 mL, or from 1.5 mL to 2.5 mL, or from 1.8 mL to 2.0 mL from the sample holding tube.
Embodiment 45: An apparatus comprising: a housing; an input port integrally formed with the housing that is structurally configured to receive contents of a sample holding tube, wherein the input port forms a part of a needle assembly structurally configured to establish fluidic communication and evacuate contents of the sample holding tube, wherein the needle assembly comprises an aspiration needle and a venting needle, wherein the venting needle is concentrically arranged within the aspiration needle, wherein the aspiration needle comprises a slot that at least partially exposes the venting needle therewithin, and wherein a tip of the venting needle is axially positioned between the slot and a tip of the aspiration needle; a fluidic manifold in fluidic communication with the input port, the fluidic manifold being configured to receive the sample from the input port and to direct a metered sample into each of two or more fluidic circuits downstream to the fluidic manifold, wherein each of the two or more fluidic circuits comprises i) a metering channel in fluid communication with the fluidic manifold, wherein the metering channel is configured to receive the metered sample from a respective output of the fluidic manifold, ii) a reagent channel in fluidic communication with the fluidic manifold, wherein the metered sample is introduced to one or more reagents located in a corresponding fluidic circuit to form a mixed sample and iii) a testing chamber in fluidic communication with the reagent channel, the testing chamber being structurally configured for interrogation by a measurement system configured to determine at least one viscoelastic property of the mixed sample.
Embodiment 46: A method of mixing a sample with one or more reagents in an apparatus and testing the mixed sample to assess hemostasis, the method comprising: receiving a sample from a sample holding tube; flowing the sample through a gas trap to facilitate separation of gases from the sample; separating the degassed sample into two or more test samples and flowing the two or more test samples into a two or more corresponding test circuits that include one or more reagents and a testing chamber; mixing the two or more test samples in the two or more test circuits with the one or more reagents to form two or more corresponding mixed aliquots; and flowing the two or more mixed aliquots to two or more corresponding testing chambers in the test circuits; and measuring one or more viscoelastic properties from the two or more mixed aliquots in the corresponding testing chambers.
Embodiment 47: The method of Embodiment 46, wherein the two or more samples are separated using a fluidic manifold and flowed into respective metering channels in fluid communication with the fluidic manifold.
Embodiment 48: The method of Embodiment 47, further comprising: adjusting the temperature of the metered sample in the metering channel to approximate body temperature prior to mixing the two or more test samples with the one or more reagents in the test circuits.
Embodiment 49: The method of any one of Embodiments 47 or 48, wherein the test fluid is moved into the metering channels through the fluidic manifold in response to a first applied positive or negative pressure that is applied by, or generated from, the measurement system.
Embodiment 50: The method of any one of Embodiments 47-49, further comprising: conditioning the metering samples in the metering channels to, or substantially near, a desired temperature, wherein the test fluid is mixed with the one or more reagents in a respective fluidic pathway following exit from the metering channels.
Embodiment 51: The method of any one of Embodiments 47-50, further comprising: isolating the test fluid in the metering channel to prevent the test fluid from contacting the one or more reagents during the filling of the metering channel.
Embodiment 52: The method of any one of Embodiments 46-51, wherein a second applied positive or negative pressure is applied by, or generated from, the measurement system at a first port in communication with the serpentine pathway so as to move a respective metered sample in the second direction.
Embodiment 53: The method of any one of Embodiments 46-52, wherein the first applied positive or negative pressure is applied by, or generated from, the measurement system in reversed so as to move a respective metered sample in the second direction.
Embodiment 54: The method of any one of Embodiments 46-53, wherein the receiving the mixed aliquot in the testing chamber further comprises: receiving a negative or differential pressure via the second pressure port, wherein the second pressure port is further in fluid communication with the testing chamber.
Embodiment 55: The method of any one of Embodiments 46-54, wherein the testing chamber is downstream of the serpentine pathway and the second pressure port is downstream of the testing chamber.
Embodiment 56: The method of any one of Embodiments 46-55, wherein the one or more reagents is in the form of one or more lyophilized beads.
Embodiment 57: The method of any one of Embodiments 46-56, wherein the one or more reagents is selected from the group consisting of an intrinsic pathway activator, an extrinsic pathway activator, and a coagulation activator.
Embodiment 58: The method of any one of Embodiments 46-57, wherein the one or more reagents is selected from the group consisting of a platelet activator, a platelet inhibitor, and an agonist.
Embodiment 59: The method of any one of Embodiments 46-58, wherein a first set of one or more reagents comprises an intrinsic pathway activator, wherein a second set of one or more reagents comprises an extrinsic pathway activator and a fibrinolysis inhibitor, wherein a third set of one or more reagents comprises an extrinsic pathway activator, and wherein a fourth set of one or more reagents comprises an extrinsic pathway activator and a platelet inhibitor.
Embodiment 60: The method of any one of Embodiments 46-59, wherein the measurement system is selected from the group consisting of a sonorheometry-based system, thromboelastography-based system, a thromboelastometry-based system, an optical-based system, a fluorescence-based system, a colorimetric-based system, an aggregometry-based system, a resonance-based system, and an electrical impedance-based system.
Embodiment 61: The method of any one of Embodiments 46-60, further comprising mixing the at least one metered sample using one or more ferromagnetic elements.
Embodiment 62: The method of any one of Embodiments 46-61, wherein the two or more mixed aliquots are flowed from a respective inlet of the two or more corresponding testing chambers to an outlet positioned located below the inlet.
Embodiment 63: The method of any one of Embodiments 47-62, wherein a sum of volumes of the metered samples in the metering channels corresponds to 60% or more, 65% or more, 70% or more, 75% or more, 80% or more, 85% or more, or 90% or more of a volume of the sample in the sample holding tube.
Embodiment 64: A method of mixing a sample with one or more reagents in an apparatus and testing the mixed sample to assess hemostasis, the method comprising: receiving a sample from a sample holding tube; separating the sample into two or more test samples and flowing the two or more test samples into a two or more corresponding test circuits that each include a metering channel, one or more reagent channels, and a testing chamber in fluidic communication; mixing the two or more test samples in the two or more test circuits with the one or more reagents to form two or more corresponding mixed aliquots; and flowing the two or more mixed aliquots to two or more corresponding testing chambers in the test circuits; and measuring one or more viscoelastic properties from the two or more mixed aliquots in the corresponding testing chambers, wherein a sum of volumes of the two or more test samples in the metering channels corresponds to 60% or more, 65% or more, 70% or more, 75% or more, 80% or more, 85% or more, or 90% or more of a volume of the sample in the sample holding tube.
Embodiment 65: An apparatus configured to perform the method of any one of Embodiments 46-64.

What is claimed is:

1. An apparatus comprising:
a housing;
an input port integrally formed with the housing that is structurally configured to receive contents of a sample holding tube;
a gas trap in fluidic communication with the input port, wherein the gas trap is structurally configured to receive a liquid sample from the input port and to facilitate separation of gases from the liquid sample; and
a fluidic manifold in fluidic communication with the gas trap, the fluidic manifold being configured to receive the sample from the gas trap and to direct the degassed sample into two or more fluidic circuits downstream to the fluidic manifold,
wherein each of the two or more fluidic circuits comprises i) a reagent channel in fluidic communication with the fluidic manifold, wherein the degassed sample is introduced to one or more reagents located in a corresponding fluidic circuit to form a mixed sample and ii) a testing chamber in fluidic communication with the reagent channel, the testing chamber being structurally configured for interrogation by a measurement system configured to determine at least one viscoelastic property of the mixed sample.

2. The apparatus of claim 1, wherein each of the two or more fluidic circuits further comprises a metering channel positioned between the fluidic manifold and the reagent channel, wherein each metering channel is configured to receive a metered sample from a respective output of the fluidic manifold.

3. The apparatus of any one of claims 1-2, wherein each respective reagent channel comprises one or more pockets configured to house at least one lyophilized bead comprising the one or more reagents.

4. The apparatus of any one of claims 1-3, wherein the input port forms a part of a needle assembly structurally configured to establish fluidic communication and evacuate contents of the sample holding tube.

5. The apparatus of claim 4, wherein the needle assembly comprises the input port and a second port, wherein the second port is configured to vent a liquid or gas into the sample holding tube so as to promote evacuation of the contents therein.

6. The apparatus of any one of claims 1-5, wherein the input port is structurally configured to couple to a luer lock configured to connect to the sample holding tube.

7. The apparatus of any one of claims 4-6, wherein the needle assembly comprises an aspiration needle and a venting needle, wherein the venting needle is concentrically arranged within the aspiration needle.

8. The apparatus of claim 7, wherein the aspiration needle comprises a slot that at least partially exposes the venting needle therewithin.

9. The apparatus of claim 8, wherein a tip of the venting needle is axially positioned between the slot and a tip of the aspiration needle.

10. The apparatus of any one of claims 7-9, wherein a tip of the aspiration needle is beveled.

11. The apparatus of any one of claims 7-10, wherein a tip of the venting needle is blunt.

12. The apparatus of any one of claims 7-11, wherein the aspiration needle and/or the venting needle are fixedly secured to the housing using one or more adhesive pockets.

13. The apparatus of claim 12, wherein the one or more adhesive pockets comprises a first adhesive pocket securing the aspiration needle and second adhesive pocket securing the venting needle.

14. The apparatus of any one of claims 1-13, further comprising a sample container guide shaped to receive the sample holding tube and to align the sample holding tube to the input port.

15. The apparatus of claim 14, wherein the sample container guide is integrally formed with the input port.

16. The apparatus of claim 14, wherein the sample container guide is separately attachable to the input port.

17. The apparatus of any one of claims 14-16, wherein an inner surface of the sample container guide comprises one or more protrusions to align the sample holding tube to the input port.

18. The apparatus of claim 17, wherein the one or more protrusions are configured to urge the sample holding tube towards a radial center of the sample container guide.

19. The apparatus of any one of claims 2-18, wherein at least a portion of the metering channels comprise a shape and/or material optimized to facilitate heating and/or cooling of the sample to, or near, a desired temperature.

20. The apparatus of claim 19, wherein the metering channel comprises a serpentine-shaped conduit.

21. The apparatus of any one of claims 2-20, wherein at least a portion of the metering channels are configured to mate with a corresponding thermal regulating system to condition the received sample to a desired temperature.

22. The apparatus of claim 21, wherein at least a portion of the metering channels are in physical proximity with a sensor of the measurement system configured to determine a temperature.

23. The apparatus of any one of claims 1-22, wherein each of the two or more fluidic circuits comprises a third set of fluid pathways in fluidic communication between a respective reagent channel and respective testing chamber, wherein at least a portion of third set of fluid pathways are arranged as a serpentine-shaped conduit.

24. The apparatus of any one of claims 2-23, wherein each of the reagent channels is connected to a respective first pressure port, wherein pressure when applied to the first pressure port causes the filling of the metering channel through the fluidic manifold.

25. The apparatus of claim 24, comprising a filter positioned within the first pressure port, wherein the filter is configured to allow air to move through the first pressure port but prevent fluid from moving there through.

26. The apparatus of claim 25, wherein the fluidic manifold is further connected to a vent port, wherein the vent port is configured to be closed while the sample is metered into an aliquot in the metering channel and further configured to be open to atmospheric pressure after the sample is metered into the aliquot in the metering channel.

27. The apparatus of any one of claims 23-26, wherein the serpentine-shaped conduits form a serpentine reservoir between the testing chambers and the reagent channels, and wherein a substantial portion of the contents of a sample holding tube is directed through the serpentine-shaped conduits.

28. The apparatus of claim 27, wherein the metered sample is alternately directed, for each of the two or more fluidic circuits, between a first position in a fluidic circuit and a second position in the fluidic circuit, wherein a path between the first position and second portion includes at least a portion of the serpentine-shaped conduit.

29. The apparatus of claim 28, wherein each of the testing chambers is connected to a second pressure port, wherein when pressure is applied to the second pressure port the test sample flows toward the testing chamber through a respective serpentine-shaped conduit.

30. The apparatus of claim 29, wherein when pressure is applied to the second pressure port in a reversed direction, the test sample flows away from the testing chamber through the respective serpentine-shaped conduit.

31. The apparatus of any one of claims 29-30, wherein the serpentine-shaped conduit includes an optical detection zone.

32. The apparatus of any one of claims 2-31, wherein each of the two or more fluidic circuits further comprise a mixing zone between the testing chamber and the metering channel, the mixing zone comprising one or more ferromagnetic elements therein.

33. The apparatus of any one of claims 1-32, wherein at least one of the two or more fluidic circuits comprises one or more quality testing ports, wherein the one or more quality testing ports is configured to be sensed optically or electrically.

34. The apparatus of any one of claims 1-33, wherein the testing chamber comprises a lens configured to direct ultrasonic pulses generated by the measurement system into the testing chamber.

35. The apparatus of any one of claims 1-34, wherein a volume of the sample in the sample holding tube is 3 mL or less, 2.5 mL or less, 2 mL or less, or from 1.5 mL to 2.5 mL, or from 1.8 mL to 2.0 mL.

36. The apparatus of any one of claims 1-35, wherein the gas trap comprises one or more capture pockets positioned above a fluid path of the sample through the gas trap, wherein the capture pockets are configured to collect and retain gases from the sample.

37. The apparatus of any one of claims 1-36, wherein the gas trap comprises one or more impedance baffles positioned in-line of the one or more capture pockets, the impedance baffles configured such that when a fluid contacts the impedance baffles, gases in the fluid are redirected towards the capture pockets.

38. The apparatus of any one of claims 1-37, wherein an inlet of the gas trap is disposed above an outlet of the gas trap.

39. The apparatus of any one of claims 1-38, wherein at least one of the reagents located in the two or more fluidic circuits is selected from the group consisting of an intrinsic pathway activator, an extrinsic pathway activator, and a coagulation activator.

40. The apparatus of any one of claims 1-39, wherein the one or more reagents includes one or more reagents selected from the group consisting of a platelet activator, a platelet inhibitor, and an agonist.

41. The apparatus of any one of claims 1-40, wherein a first set of one or more reagents comprise an intrinsic pathway activator, wherein a second set of one or more reagents comprises an extrinsic pathway activator and a fibrinolysis inhibitor, wherein a third set of one or more reagents comprises an extrinsic pathway activator, and wherein a fourth set of one or more reagents comprises an extrinsic pathway activator and a platelet inhibitor.

42. The apparatus of any one of claims 1-41, wherein the measurement system is selected from the group consisting of a sonorheometry-based system, thromboelastography-based system, a thromboelastometry-based system, an optical-based system, a fluorescence-based system, a colorimetric-based system, an aggregometry-based system, a resonance-based system, and an electrical impedance-based system.

43. An apparatus comprising:
a housing;
an input port integrally formed with the housing that is structurally configured to receive contents of a sample holding tube;
a fluidic manifold in fluidic communication with the input port, the fluidic manifold being configured to receive the sample from the input port and to direct a metered sample into each of two or more fluidic circuits downstream to the fluidic manifold,
wherein each of the two or more fluidic circuits comprises i) a metering channel including a serpentine-shaped conduit in fluid communication with the fluidic manifold, wherein the metering channel is configured to receive the metered sample from a respective output of the fluidic manifold, ii) a reagent channel in fluidic communication with the metering channel, wherein the metered sample is introduced to one or more reagents located in a corresponding fluidic circuit to form a mixed sample, and iii) a testing chamber in fluidic communication with the reagent channel, the testing chamber being structurally configured for interrogation by a measurement system configured to determine at least one viscoelastic property of the mixed sample.

44. An apparatus comprising:
a housing;
an input port integrally formed with the housing that is structurally configured to receive contents of a sample holding tube;
a fluidic manifold in fluidic communication with the input port, the fluidic manifold being configured to receive the sample from the input port and to direct a metered sample into each of two or more fluidic circuits downstream to the fluidic manifold,
wherein each of the two or more fluidic circuits comprises i) a metering channel in fluid communication with the fluidic manifold, wherein the metering channel is configured to receive the metered sample from a respective output of the fluidic manifold, ii) a reagent channel in fluidic communication with the fluidic manifold, wherein the metered sample is introduced to one or more reagents located in a corresponding fluidic circuit to form a mixed sample and iii) a testing chamber in fluidic communication with the reagent channel, the testing chamber being structurally configured for interrogation by a measurement system configured to determine at least one viscoelastic property of the mixed sample,
wherein the apparatus is configured to receive a sample of less than 3 mL, less than 2.5 mL, less than 2 mL, or from 1.5 mL to 2.5 mL, or from 1.8 mL to 2.0 mL from the sample holding tube.

45. An apparatus comprising:
a housing;
an input port integrally formed with the housing that is structurally configured to receive contents of a sample holding tube, wherein the input port forms a part of a needle assembly structurally configured to establish fluidic communication and evacuate contents of the sample holding tube, wherein the needle assembly comprises an aspiration needle and a venting needle, wherein the venting needle is concentrically arranged within the aspiration needle, wherein the aspiration needle comprises a slot that at least partially exposes the venting needle therewithin, and wherein a tip of the venting needle is axially positioned between the slot and a tip of the aspiration needle;
a fluidic manifold in fluidic communication with the input port, the fluidic manifold being configured to receive the sample from the input port and to direct a metered sample into each of two or more fluidic circuits downstream to the fluidic manifold,
wherein each of the two or more fluidic circuits comprises i) a metering channel in fluid communication with the fluidic manifold, wherein the metering channel is configured to receive the metered sample from a respective output of the fluidic manifold, ii) a reagent channel in fluidic communication with the fluidic manifold, wherein the metered sample is introduced to one or more reagents located in a corresponding fluidic circuit to form a mixed sample and iii) a testing chamber in fluidic communication with the reagent channel, the testing chamber being structurally configured for interrogation by a measurement system configured to determine at least one viscoelastic property of the mixed sample.

46. A method of mixing a sample with one or more reagents in an apparatus and testing the mixed sample to assess hemostasis, the method comprising:
receiving a sample from a sample holding tube;
flowing the sample through a gas trap to facilitate separation of gases from the sample;
separating the degassed sample into two or more test samples and flowing the two or more test samples into a two or more corresponding test circuits that include one or more reagents and a testing chamber;
mixing the two or more test samples in the two or more test circuits with the one or more reagents to form two or more corresponding mixed aliquots; and
flowing the two or more mixed aliquots to two or more corresponding testing chambers in the test circuits; and
measuring one or more viscoelastic properties from the two or more mixed aliquots in the corresponding testing chambers.

47. The method of claim 46, wherein the two or more samples are separated using a fluidic manifold and flowed into respective metering channels in fluid communication with the fluidic manifold.

48. The method of claim 47, further comprising:
adjusting the temperature of the metered sample in the metering channel to approximate body temperature prior to mixing the two or more test samples with the one or more reagents in the test circuits.

49. The method of any one of claim 47 or 48, wherein the test fluid is moved into the metering channels through the fluidic manifold in response to a first applied positive or negative pressure that is applied by, or generated from, the measurement system.

50. The method of any one of claims 47-49, further comprising:
conditioning the metering samples in the metering channels to, or substantially near, a desired temperature, wherein the test fluid is mixed with the one or more reagents in a respective fluidic pathway following exit from the metering channels.

51. The method of any one of claims 47-50, further comprising:
isolating the test fluid in the metering channel to prevent the test fluid from contacting the one or more reagents during the filling of the metering channel.

52. The method of any one of claims 46-51, wherein a second applied positive or negative pressure is applied by, or generated from, the measurement system at a first port in communication with the serpentine pathway so as to move a respective metered sample in the second direction.

53. The method of any one of claims 46-52, wherein the first applied positive or negative pressure is applied by, or generated from, the measurement system in reversed so as to move a respective metered sample in the second direction.

54. The method of any one of claims 46-53, wherein the receiving the mixed aliquot in the testing chamber further comprises:
receiving a negative or differential pressure via the second pressure port, wherein the second pressure port is further in fluid communication with the testing chamber.

55. The method of any one of claims 46-54, wherein the testing chamber is downstream of the serpentine pathway and the second pressure port is downstream of the testing chamber.

56. The method of any one of claims 46-55, wherein the one or more reagents is in the form of one or more lyophilized beads.

57. The method of any one of claims 46-56, wherein the one or more reagents is selected from the group consisting of an intrinsic pathway activator, an extrinsic pathway activator, and a coagulation activator.

58. The method of any one of claims 46-57, wherein the one or more reagents is selected from the group consisting of a platelet activator, a platelet inhibitor, and an agonist.

59. The method of any one of claims 46-58, wherein a first set of one or more reagents comprises an intrinsic pathway activator, wherein a second set of one or more reagents comprises an extrinsic pathway activator and a fibrinolysis inhibitor, wherein a third set of one or more reagents comprises an extrinsic pathway activator, and wherein a fourth set of one or more reagents comprises an extrinsic pathway activator and a platelet inhibitor.

60. The method of any one of claims 46-59, wherein the measurement system is selected from the group consisting of a sonorheometry-based system, thromboelastography-based system, a thromboelastometry-based system, an optical-based system, a fluorescence-based system, a colorimetric-based system, an aggregometry-based system, a resonance-based system, and an electrical impedance-based system.

61. The method of any one of claims 46-60, further comprising mixing the at least one metered sample using one or more ferromagnetic elements.

62. The method of any one of claims 46-61, wherein the two or more mixed aliquots are flowed from a respective inlet of the two or more corresponding testing chambers to an outlet positioned located below the inlet.

63. The method of any one of claims 47-62, wherein a sum of volumes of the metered samples in the metering channels corresponds to 60% or more, 65% or more, 70% or more, 75% or more, 80% or more, 85% or more, or 90% or more of a volume of the sample in the sample holding tube.

64. A method of mixing a sample with one or more reagents in an apparatus and testing the mixed sample to assess hemostasis, the method comprising:
receiving a sample from a sample holding tube;
separating the sample into two or more test samples and flowing the two or more test samples into a two or more corresponding test circuits that each include a metering channel, one or more reagent channels, and a testing chamber in fluidic communication;
mixing the two or more test samples in the two or more test circuits with the one or more reagents to form two or more corresponding mixed aliquots; and
flowing the two or more mixed aliquots to two or more corresponding testing chambers in the test circuits; and
measuring one or more viscoelastic properties from the two or more mixed aliquots in the corresponding testing chambers,
wherein a sum of volumes of the two or more test samples in the metering channels corresponds to 60% or more, 65% or more, 70% or more, 75% or more, 80% or more, 85% or more, or 90% or more of a volume of the sample in the sample holding tube.

65. An apparatus configured to perform the method of any one of claims 46-64.
